(19) United States
(12) Patent Application Publication
(10) Pub. No.: US 2004/0215448 A1
(43) Pub. Date: Oct. 28, 2004

(54) Speech quality evaluation system and an apparatus used for the speech quality evaluation

(75) Inventors: Kazuhiko Funatsu, Kanagawa (JP); Keiko Yanagita, Miyazaki (JP); Taiji Katsube, Tokyo (JP)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: AGILENT TECHNOLOGIES, INC.

(21) Appl. No.: 10/807,989

(22) Filed: Mar. 24, 2004

(30) Foreign Application Priority Data
Mar. 26, 2003 (JP) 2003-084775

(51) Int. Cl. G10L 19/12

(52) U.S. Cl. 704/201

(57) ABSTRACT

A speech quality evaluation system comprising: (1) sound quality evaluation units; and (2) network analyzers. The speech quality evaluation system transmits sound signals used for evaluation from the sound quality evaluation unit; the network analyzer captures a packet which corresponds to the sound part of the sound signals used for evaluation; receives the sound signals used for evaluation which have become degraded in passing through the IP network; and the network analyzer captures a packet which corresponds to the sound part of the sound signals used for evaluation.

### FIELD OF THE INVENTION

The present invention relates to a system which is used to evaluate the quality of telephone speech which passes through a packet network such as an IP (Internet Protocol) network.

### BACKGROUND OF THE INVENTION

The IP telephone system using an IP network is attracting attention as a telephone system which will replace preexisting telephone systems using an STM (Synchronous Transfer Mode) network. There are a number of different types of IP telephone systems including: (1) the type which requires only a telephone set; (2) the type which uses an adapter and a telephone set; and (3) the type which uses a computer and dedicated software; and the like. These different types of service are known as the “IP telephony” and “Internet telephony” and are enjoying a thriving market. Further, in this document, we shall refer to the service which makes use of the IP telephone system as the “IP telephone service”.

In the different types of IP telephone services available, not only is the call rate extremely important, but the speech quality of the telephone call is important as well. People expect a greater variety of services from an IP telephone service than from preexisting telephone systems. Some users focus on the speech quality of the call rather than on how much it costs. Other users are looking at how much the call costs rather than the speech quality of the call. As a result, the service provider should specify the cost with speech quality. IP telephone services are provided not only exclusively using the IP network but are sometimes provided by interconnecting IP networks of multiple service providers. In this case, the service providers must know beforehand the speech quality of the call in the other IP service providers' IP networks to assure a uniform speech quality for the users. As a result, the service providers must provide a certain level of speech quality even for other service providers.

There are three basic methods which are used to evaluate the speech quality of IP telephone calls. The first method involves evaluating the transfer quality of the IP network. The second method involves measuring the clarity of the speech between telephone terminals. The third method involves measuring the R-value.

The transfer quality of an IP network is evaluated using the packet loss rate in the IP network, the amount of packet delay, the throughput and similar parameters. Measuring these parameters involves transmitting a packet at a location in the IP network and either capturing the packet which has been transmitted at another location in the IP network or simply capturing the packet at a location in the IP network.

There are several methods which can be used for measuring the clarity of the speech between telephone terminals. The MOS (ITU-T Recommendation P. 800) is an example of these. In the MOS method, sounds which have become degraded passing through a telephone network which comprises an IP network are evaluated by integers indicating five registers which are actually audible to humans. The clarity of the speech is measured by taking the average of the evaluation results. When this method is used, it is possible to make an evaluation which is closest to the communication quality actually perceived by a human user. However, this method is both time-consuming and labor-intensive and the results depend on the subjectivity of the person making the evaluation.

The PSQM (ITU-Recommendation G.861) method can be used to resolve these problems. The PSQM method is used to compare the original sound and the sound which has become degraded by passing through the network. It is simple to use and objectively measures the clarity of the speech. Besides the PSQM method mentioned previously, this type of evaluation method, that is, a method which measures the clarity of the speech both objectively and mechanically, includes the PSQM99 method, the PAMS method and the PESQ method (ITU-T Recommendation G.862).

Suggestions for the determination method using the R-value are contained in ITU-T Recommendation G.107. The R-value is found by calculations based on a great many parameters which are measured. Since it is by no means easy to measure all of these parameters, the default values for each of the parameters are indicated in Recommendation G.107. For example, ambient room noise parameter which are sounds on the receiving side and other types of parameter often times use fixed values which assume certain conditions. Needless to say, in determining an appropriate R-value, the sound quality, the loudness of the echo as well as the amount of delay must all be measured. Compared to evaluating the aforementioned transfer quality and measuring the clarity of the speech, the R-value is calculated by using the overall speech quality of the call which takes into consideration the echo, the delay and other factors. As a result, there is a need for a method which makes it possible to evaluate the degree of satisfaction of the person using the service relative to the quality of the speech when an IP telephone service is provided.

In recent years, as international standards organizations have adopted standardized R-values, there has been a trend towards providing conventionally used speech quality evaluation devices and speech quality evaluation software with R-value determining functions. From this point onward, we shall refer generically to speech quality evaluation device and speech quality evaluation software as “speech quality evaluation unit”, respectively. We shall also refer generically to speech quality evaluation device and speech quality evaluation software which are provided with an R-value determining function as the “R-value determining unit”, respectively.

Despite the above, Recommendation G.107 makes no specific reference to a method for evaluating the speech quality of the call. Recommendation G.107 is a method which is used to evaluate the sound quality and does nothing more than enumerate a method (ITU-T Recommendation G.113) which is used to calculate the value from: (1) the packet loss rate and (2) the type of the voice-encoding method as well as a method which is used to calculate sound voice quality from the objective MOS (ITU-T Recommendation P.800). In addition to the determination of the R-value, the method for evaluating the R-value has been standardized by the other international standards organizations. Nevertheless, none of these international standards organizations have explicitly set forth standards for determining the R-value as has been set forth in the ITU-T Recommendation.

As a result, the conventional R-value determining units determine the R-value by using a variety of different methods. For example, there is an R-value determining units which is used to easily determine the R-value solely from the random packet loss rate of the IP network and an R-value determining unit which is used to calculate the R-value solely from the clarity of the speech and the amount of sound delay. However, the R-value which is determined by these R-value determining units is problematical in that it does not accurately coincide with the speech quality of a call experienced by the person using the IP telephone service. For example, the service provider sometimes obtains a good R-value in a time zone wherein the degrading of the speech quality of a call has been pointed out. This type of problem which occurs in the conventional devices oftentimes arises due to the method of measuring the data used to evaluate the quality of the speech as well as the method for evaluating the speech quality of the call.

The R-value determining units of the prior art were also problematical in that they could not be used for continuous determining over long periods of time. The R-value was devised to design the network and not for the evaluation of the speech quality of a call. As a result, determination of the R-value was sufficient as long as it involved a single measurement and no function was required for continuous determination of the R-value. However, the value guaranteed by the service providers was generally of the worst speech quality of a call, so that the R-value during service had to be determined continuously. The traffic volume of the network which affected the speech quality of the call changed greatly depending on the time zone, the day of the week or holiday and other time elements. The abrupt fluctuations in traffic at the end of the year and the beginning of the year were particularly astonishing. As a result, the service providers had to determine the R-value during service for at least one year.

There were also problems in that the speech quality evaluation units of the prior art were not suitable for dealing with trouble in the communications system. For example, a speech quality evaluation unit which evaluated the transfer quality of an IP network and an R-value determining unit which easily calculated the R-value solely from the random packet loss rate of the IP network could not detect any degradation in the quality of speech arising from a VoIP (voice-over IP) gateway device or a VoIP adapter or other coding device. In addition, a speech quality unit which measure the clarity of the speech between telephone terminals and an R-value determining unit which the R-value is determined from the amount of sound delay the clarity of the speech between telephone terminals could detect degradation in the quality of speech between telephone terminals but they could not find the degradation factors for the speech quality of the call could be specified.

In short, even though the speech quality evaluation units of the prior art were capable of determining the R-value, it was impossible to continuously evaluate the type of speech quality of a call which could be perceived by humans. In addition, the speech quality evaluation units of the prior art were not suitable for dealing with degradation in the quality of speech. There is an urgent need for providers to set up an IP telephone service as well as a need for tools required for handling this service. Therefore, it is an object of the present invention to provide a system for evaluating the quality of speech which lends itself to IP telephone service management. It is another object of the present invention to provide a device, method or program which is required for providing the aforementioned evaluation system.

### SUMMARY OF THE INVENTION

The present invention has been developed to attain the aforementioned objects. The first object of the invention is a system which is used to evaluate the speech quality of a call between telephone terminals via a packet network provided with: (1) a sound signal transmitter which transmits sound signals in a system; (2) a first packet capturing device which captures a first packet which corresponds to the aforementioned sound signals; (3) a sound signal receiver which receives the aforementioned sound signals which have become degraded in passing through the aforementioned packet network; (4) a second packet capturing device which captures a second packet which corresponds to the aforementioned sound signals which have been degraded; and (5) a speech evaluation means which evaluates the speech quality of a call between the aforementioned telephone terminals using the first sound signals transmitted by the sound signal transmitter, the second sound signals received by the sound signal receiver, the aforementioned first packet and the aforementioned second packet.

The second object of the invention is characterized as a system being provided with: (1) the aforementioned first packet capturing device and the aforementioned second packet capturing device which capture the packets which correspond to the sound part of the aforementioned sound signals.

The third object of the invention is characterized as using the aforementioned speech quality evaluation means according to the first or the second object of the invention and determining the amount of sound delay by comparing the aforementioned sound signals which are transmitted by the aforementioned sound signal transmitter and the aforementioned sound signals which are received by the aforementioned sound signal receiver for each sound part of the various signals so that the speech quality of a call between the aforementioned telephone terminals is evaluated using the aforementioned amount of sound delay.

The fourth object of the invention involves using the aforementioned speech quality evaluation means according to the first or second objects of the invention, determining the amount of packet delay by comparing the aforementioned first packet and the aforementioned second packet for each packet which has the same identifying number and evaluating the speech quality of a call between the aforementioned telephone terminals using the aforementioned amount of packet delay.

The fifth object of the invention is also characterized as being a system provided with: (1) a first means which is used to decode the sound signals from the aforementioned first packet; and (2) a second means which is used to decode sound signals from the aforementioned second packet, according to the first or the second object of the invention; it uses the aforementioned speech quality evaluation means to determine the amount of sound delay by comparing the aforementioned first decoded sound signals and the aforementioned second decoded sound signals.

The sixth object of the invention is also characterized as ensuring that the aforementioned first decoded sound signals and the aforementioned second decoded sound signals, according to the fifth object of the invention, are compared for each sound part.

The seventh object of the invention involves using the aforementioned speech evaluation means according to the fifth or the sixth object of the invention to evaluate the speech quality of a call between the aforementioned telephone terminals by using the aforementioned amount of sound delay which has been determined as the amount of delay in packets between the first packet capturing device and the second packet capturing device.

The eighth object of the invention involves using the aforementioned speech quality evaluation means according to the third through the seventh objects of the invention to evaluate the speech quality of a call between the aforementioned telephone terminals by determining the R-value using the aforementioned amount of sound delay or the aforementioned amount of packet delay.

The ninth object of the invention is a system according to the fourth through seventh object of the invention provided with a display means; said display means displays in a time series format the mean value at an indicated time period for the amount of packet delay which has been determined by using the aforementioned speech quality evaluation unit. It also involves displaying in overlapping form the amplitude of fluctuations during the aforementioned prescribed period of time for the amount of packet delay which is determined relative to the mean value during the aforementioned prescribed time period.

The tenth object of the invention is a system according to the eighth object of the invention provided with a display means; the aforementioned display means displays in a time series format the mean value during a prescribed time for the R-value which is determined using the aforementioned speech quality evaluation means and displays in overlapping form the amplitude of fluctuations during the aforementioned prescribed time for the R-value which is determined, relative to the mean value during the aforementioned prescribed period for the R-value which is determined.

The eleventh object of the invention involves the aforementioned display means according to the tenth object of the invention. When the locations where the aforementioned R-value has been degraded have been selected on the display screen, (1) the amount of delay as well as (2) any defects determined by partitioning the communication between the telephone terminals into multiple sections are displayed.

The twelfth object of the invention is a system according to the first through the eleventh objects of the invention provided with a control means; said control means is used to evaluate the aforementioned telephone terminals in prescribed time units whether or not the evaluation has been completed.

The thirteenth object of the invention is a system according to the twelfth object of the invention provided with the aforementioned control means which repeatedly makes an evaluation in the aforementioned prescribed time units according to a schedule or makes the evaluation while making changes in the combination of the aforementioned telephone terminals according to a schedule.

The fourteenth object of the invention involves adjusting the aforementioned sound signals which are transmitted by the aforementioned sound signal transmitter according to the twelfth or the thirteenth object of the invention are adjusted so that the evaluation of speech quality between the aforementioned telephone terminals is completed within the prescribed period of time as indicated above.

The fifteenth object of the invention is a system according to the first through the fourteenth object of the invention provided with a database means; when the speech quality which has been evaluated has been degraded relative to a predetermined value, at least one of the following—the sound signals which are transmitted by the aforementioned sound signal transmitter, the sound signals which are received by the aforementioned sound signal receiver, the aforementioned first packet or the aforementioned second packet—is (are) stored in the aforementioned database means.

The sixteenth object of the invention involves the aforementioned first packet capturing device and the aforementioned second packet capturing device according to the first through the fifteenth objects of the invention—which are provided with a time synchronization means which stores a packet which has been captured along with the time stamp which has been synchronized.

The present invention will be described in detail in the following drawings and description.

### BRIEF DESCRIPTION OF THE DRAWINGS

FIG. 1 is a diagram indicating the basic configuration of the system used to evaluate the speech quality of a call which is the first embodiment of the present invention.

FIG. 2 is a diagram indicating the time relationship between the voice signals and the packets in the system used to evaluate the speech quality of a call which is the first embodiment of the present invention.

FIG. 3 is a flowchart indicating the operations for a system used to evaluate the speech quality of a call which is the first embodiment of the present invention.

FIG. 4 is a flowchart indicating the operations for a system used to evaluate the speech quality of a call which is the first embodiment of the present invention.

FIG. 5 demonstrates an example of the display of results in the system used to evaluate the speech quality of a call which is the first embodiment of the present invention.

FIG. 6 demonstrates the procedure for determining the packet delay in the system used to evaluate the speech quality of a call which is the third embodiment of the present invention.

FIG. 7 is a diagram indicating the basic configuration of the system used to evaluate the speech quality of a call which is the fourth embodiment of the present invention.

FIG. 8 demonstrates the time relationship between the voice signals and packets in a system used to evaluate the speech quality of a call which is the fourth embodiment of the present invention.

FIG. 9 is a flowchart indicating the operations for a system used to evaluate the speech quality of a call which is the fourth embodiment of the present invention.

FIG. 10 is a flowchart indicating the operations for a system used to evaluate the speech quality of a call which is the fourth embodiment of the present invention.

FIG. 11 is a flowchart indicating the operations for a system used to evaluate the speech quality of a call which is the fifth embodiment of the present invention.

FIG. 12 demonstrates an example of the display of results in a system 600 used to evaluate the speech quality of a call.

### DETAILED DESCRIPTION OF THE PREFERRED EMBODIMENT

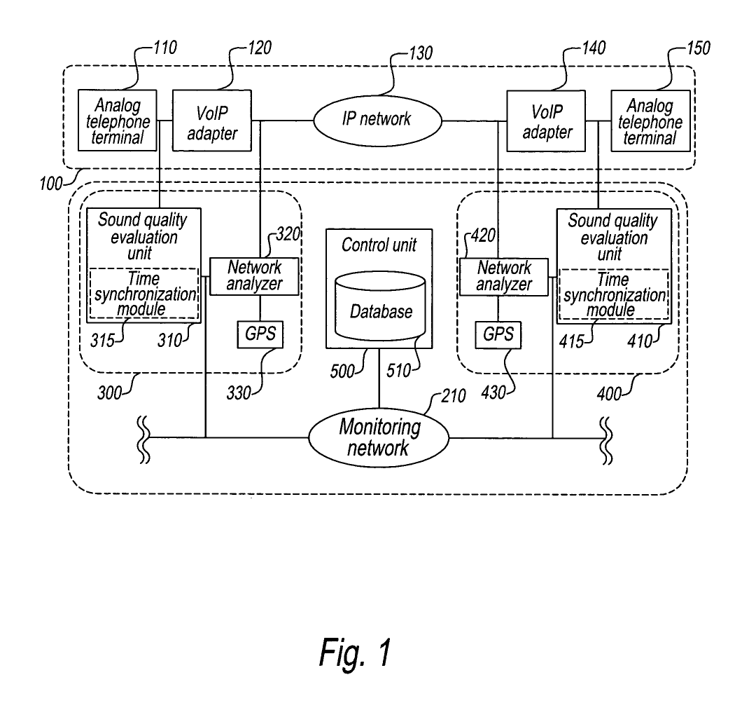

The first embodiment of the present invention is a speech quality evaluation system as indicated by the basic block diagram in FIG. 1. Further, FIG. 1 indicates a telephone system 100 using an IP network 130 and a speech quality evaluation system 200. The telephone system 100 is made up of: (1) analog telephone terminals 110 and 150 which are used in the prior art; (2) VoIP adapters 120 and 140 which are used to connect the analog telephone terminals to the IP network; and (3) IP network 130.

The speech quality evaluation system 200 is provided with: (1) a sub-system 300 which is located at analog telephone terminal 110 side; (2) a sub-system 400 which is located at analog telephone terminal 150 side; (3) a control device 500 which is used to control the entire system; and (4) a management network 210.

The sub-system 300 is provided with: (1) a sound quality evaluation unit 310; (2) a network analyzer 320; and (3) a GPS (Global Positioning System) 330.

The sound quality evaluation unit 310 connects the analog telephone terminal 110, the Vo IP adapter 120 and is used to measure the clarity of the speech, the amount of sound delay, the loudness of the echo and similar parameters for the analog telephone terminal 110. More specifically, the sound quality evaluation unit 310 is used to originate a call-request and accept the call-request and to transmit and receive sound signals to be used for evaluation, instead of the analog telephone terminal 110. The sound quality evaluation unit 310 stores inside the device those signals which have been transmitted and received and evaluates the sound quality from the signals which have been transmitted and received. The sound signals which are used for evaluation are recorded voices of people speaking and there are several types of these sound signals depending on the language used, the gender, age and time of reproducing the signals. DTMF sound signals are also included in the sound signals used for evaluation. The sound signals used for evaluation which are transmitted and the sound signals which are received are digitally encoded and stored as sound data inside the sound quality evaluation unit 310. In addition, the sound quality evaluation unit 310 is provided with a time synchronization module which is based on the NTP. The clock inside the sound quality evaluation unit 310 can be set to an accuracy of approximately several milliseconds.

The network analyzer 320 is a device which captures a packet which is exchanged between the VoIP adapter 120 and the IP network 130 and evaluates the quality of the transmission. The packets which have been captured have a time stamp attached when the individual packets are captured. The network analyzer 320 is also provided with a filter function which enables it to capture only a packet which satisfies predetermined conditions. The filter conditions include source address, destination address, port number and similar information. The network analyzer 320 is connected to the GPS 330 and the time inside the network analyzer 320 can be determined at approximately several nanoseconds of precision.

The sub-system 400 is provided with the sound quality evaluation unit 410, network analyzer 420 and GPS 430.

The sound quality evaluation unit 410 is connected between the analog telephone terminal 150 and VoIP adapter 140 and is used to measure the clarity of the speech of the sound, the amount of sound delay and the loudness of the echo in the analog telephone terminal 150. More specifically, the sound quality evaluation unit 410 is used to originate a call-request and accept the call-request and to transmit and receive sound signals used for evaluation, instead of the analog telephone terminal 150. The sound quality evaluation unit 410 stores inside the device those signals which have been transmitted and received and evaluates the sound quality from the signals which have been transmitted and received. The sound signals which are used for evaluation are recorded voices of people speaking and there are several types of these sound signals depending on the language used, the gender, age and time of reproducing the signals. DTMF sound signals are also included in the sound signals used for evaluation. The sound signals used for evaluation which are transmitted and the sound signals which are received are digitally encoded and stored as sound data inside the sound quality evaluation unit 410. In addition, the sound quality evaluation unit 410 is provided with a time synchronization module 415 which is based on the NTP. The clock inside the sound quality evaluation unit 410 can be set to an accuracy of approximately several milliseconds.

The network analyzer 420 is a device which captures a packet which is exchanged between the VoIP adapter 140 and the IP network 130 and evaluates the quality of the transmission. The packets which have been captured have a time stamp attached when the individual packets are captured. The network analyzer 420 is also provided with a filter function whereby only a packet which satisfies predetermined conditions is captured. These conditions include the source address, the destination address, the port number and similar information. The network analyzer 420 is connected to the GPS 430 and the clock inside the network analyzer 420 can be set to an accuracy of approximately several nanoseconds.

Next, we shall refer to the sound quality evaluation units 310 and 410 as well as to network analyzers 320 and 420 which are referred to generically as “sound quality evaluation unit 310 and the rest”.

The control unit 500 is a computer unit which is used to control the overall speech quality evaluation system 200. The control unit 500 is operated by executing a program which is stored in memory, in a hard disk drive and other memory devices (not shown in the figure). As a result, the control unit 500 is provided with at least one CPU (central processing unit) which carries out computing and preferably is provided with an extra DSP (digital signal processor) or multiple CPUs and carries out computing in parallel. The control unit 500 controls sound quality evaluation unit 310 and the rest via a management network 210 and communicates a variety of data and setting information with the sound quality evaluation unit 310 and the rest. The control unit 500 is also provided with a database 510. In this database 510 are stored initial setting information for sound quality evaluation unit 310, the rest, as well as operating procedures for sound quality evaluation unit 310 and the rest of the other data and the other setting information. Further, the database 510 is accessed freely by external devices via a management network 210.

The management network 210 is a network which is used for control and data telecommunications. The control unit 500 and the sound quality evaluation unit 310 and the rest are connected to the management network 210 and can communicate with one another.

Further, several of the devices which make up the speech quality evaluation system 200 may be placed in a single integrated unit. Needless to say, all of these devices may be contained in a single unit. In addition, several units which make up the speech quality evaluation system 200 may be combined to form part of the telephone system 100. For example, the sub-system 300 may be combined with the VoIP adapter 120 or the sub-system 400 may be combined with the VoIP adapter 140.

The speech quality of a call between the analog telephone terminal 110 and the analog telephone terminal 150 in the speech quality evaluation system 200 which is configured as indicated above is evaluated according to the clarity of the speech, R-value, amount of sound delay, loudness of the echo, amount of packet delay or the throughput and other parameters. These parameters are referred to collectively as “speech quality evaluation values”. Further, the clarity of the speech is the value which is obtained from an objective and mechanical clarity of the speech measuring method such as the PESQ method and similar techniques.

The speech quality evaluation value is obtained as indicated below. Determining the amount of packet delay and the throughput involve: (1) transmitting sound signals used for evaluation from one sound quality evaluation unit; (2) capturing the packet which corresponds to the sound signals used for evaluation which transmitted the packet which corresponds to the sound signals used for evaluation which have become degraded in passing through the IP network 130 by the network analyzers 320 and 420; and (3) comparing the respective packet which have been captured by each network analyzer. Determining clarity of the speech involves: (1) transmitting the sound signals used for evaluation from one sound quality evaluation unit; (2) receiving the sound signals used for evaluation which have become degraded passing through the IP network 130 by the same sound quality evaluation unit or the other sound quality evaluation unit; and (3) comparing the sound signals which have been transmitted and the sound signals which have been received. Determining the amount of sound delay involves: (1) transmitting sound signals used for evaluation from one sound quality evaluation unit; (2) receiving said sound signals which have been looped back from another sound quality evaluation unit; and (3) comparing the sound signals which have been transmitted and the sound signals which have been received. The loudness of the echo is measured by transmitting sound signals used for evaluation from one sound quality evaluation unit and by measuring these signals using the same sound quality evaluation unit. The R-value is found by calculating from the clarity of the speech and the amount of packet delay which are obtained as indicated above.

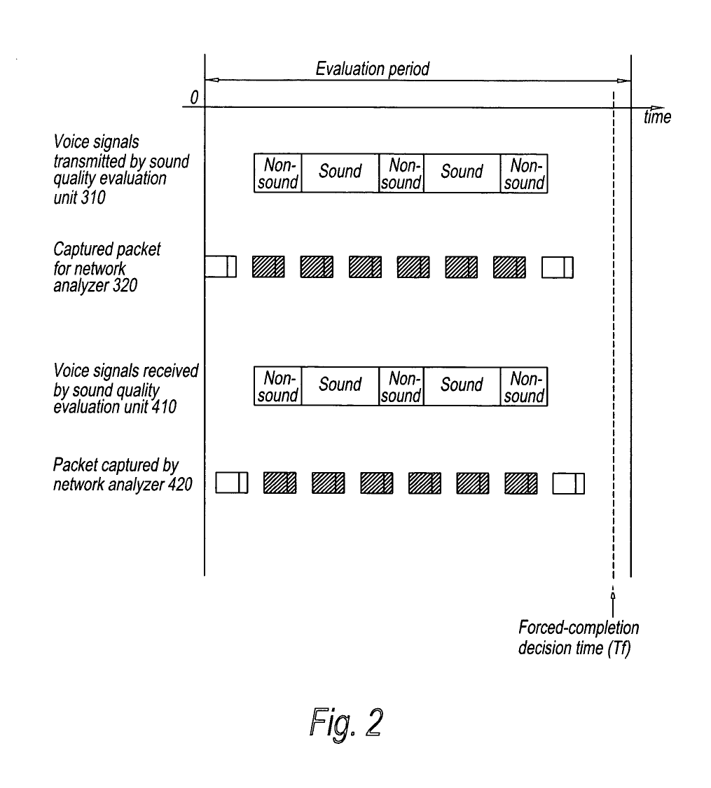

Here, the time relationship between: (1) the sound signals which have been transmitted; (2) the sound signals which are received; and (3) the packet which has been captured is indicated in FIG. 2. Further, FIG. 2 indicates the time relationship when the sound signals are transmitted from the sound quality evaluation unit 310 and received by the sound quality evaluation unit 410 in FIG. 1.

FIG. 2 indicates in the following order: (1) the sound signals which are transmitted by the sound quality evaluation unit 310; (2) the packet which is captured by the network analyzer 320; (3) the sound signals which are received by the sound quality evaluation unit 410; and (4) the packet which is captured by the network analyzer 420. These sound signals and packets are related to speech from a single call which is made within a single evaluation period. In addition, the process of transmitting and receiving the sound signals and the process of capturing the packets start and complete within a predetermined evaluation period. The two vertical unbroken lines in the Fig. indicate the following: The solid line on the left indicates the starting time for one evaluation and the solid line on the right indicates the time the same evaluation is completed.

The sound signals which are transmitted from the sound quality evaluation unit 310 are transmitted with a slight delay once the evaluation procedure starts. This happens because the sound signals are transmitted after the call has been set up between the sound quality evaluation unit 310 and the sound quality evaluation unit 410. In addition, the sound signals which have been transmitted are made up of at least one type of sound signals used for evaluation and are preferably made up of a series of different types of sound signals used for evaluation. Further, these sound signals used for evaluation are separated from one another by non-sound sound signals in order to hold in check the effect of an echo. As a result, the sound signals which are transmitted from the sound quality evaluation unit 310 are mixed together in the form of sound parts and non-sound parts. In addition, the sound signals used for evaluation may include recorded conversations and the sound parts and non-sound parts may be mixed together in the signals. After sound signals have been transmitted (which are not indicated in the figure), the sound quality evaluation unit 310 disconnects the call.

The sound signals which are received by the sound quality evaluation unit 410 are sound signals which are transmitted from the sound quality evaluation unit 310 and which have been degraded by passing through the IP network 130. In addition, the sound signals which are received start to be received at a slight delay after the evaluation starts. This happens because, as indicated above, the sound signals are transmitted after a call has been set up for the sound signals. Further, there is a slight non-sound part at the beginning of a sound signals which is received. This happens because the sound signals which are transmitted from the sound quality evaluation unit 310 reach the sound quality evaluation unit 410 with a slight delay.

Packets which have been captured by the network analyzer 320 are packets which correspond to the sound signals which are transmitted by the sound quality evaluation unit 310. Actually, the network analyzer 320 filter is set so that the RTP (Real Time Transport Protocol) packet whose source address is the address of VoIP adapter 120 and whose destination address is VoIP adapter 140 is captured. This RTP packet is also called the “sound packet”. In FIG. 2, the packets which have been captured are indicated by diagonal lines. Further, the unpatterned packets are packets which are not associated with the sound signals such as control packet and are not captured. For facility of explanation we will say that there are eight packets which correspond to the sound signals which are transmitted by the sound quality evaluation unit 310. Needless to say, there may be more than eight packets in actual practice.

A packet which has been captured by the network analyzer 420 is a packet which corresponds to the sound signals which are received by the sound quality evaluation unit 410. Actually, the network analyzer 420 filter is set so that the RTP (Real Time Transport Protocol) packet whose source address is the address of VoIP adapter 120 and whose destination address is VoIP adapter 140 is captured. In FIG. 2, the packets which are captured are indicated by diagonal lines. Further, unpatterned packets are packets which are not associated with the sound signals such as control packet and are not captured. As was the case above, there are also eight packets here which correspond to the sound signals which are transmitted by the sound quality evaluation unit 410.

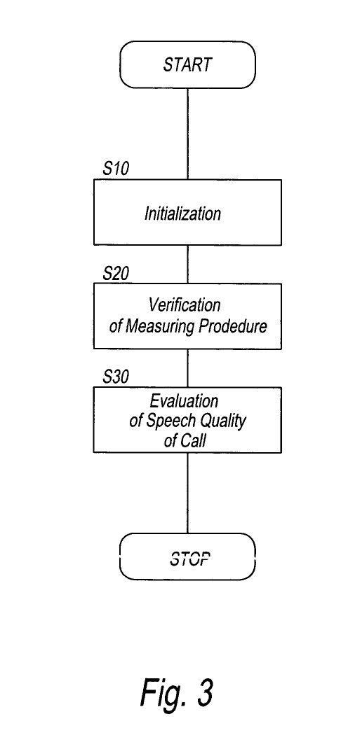

Next, we shall describe the operating procedure for the speech quality evaluation system 200. Here, a schematic flowchart which indicates how the speech quality evaluation system 200 operates is given in FIG. 3. Further, these operating procedures are carried out by a program which is executed by the control unit 500.

First, in Step S10, the control unit 500 is used to carry out initialization for the sound quality evaluation unit 310 and the rest. For example, the control unit 500 is used to set the telephone number and IP address and other information for the sound quality evaluation units 310 and 410.

Next, in Step S20, the operating procedure which is set in the sound quality evaluation unit 310 and the rest is verified. A certain speech quality evaluation must not influence another temporally adjacent speech quality evaluation. Therefore, a single speech quality evaluation must be completed within a predetermined period of time. However, that evaluation time may be extended depending to the conditions of the telephone system 100 which is to be evaluated. For example, time is sometimes required to set up the call as well as disconnect it and an evaluation is sometimes not completed within the specified period of time due to a temporary service interruption while the call is in progress. If one waits for the end of the evaluation before making another evaluation, it is possible that the speech quality of the call cannot be evaluated periodically. Therefore, in this step, an operating procedure which is established for the sound quality evaluation unit 310 and the rest is carried out on a test basis. Verification is made to see whether a single speech quality evaluation has been completed within a predetermined period of time or not and if necessary the sound signals used for evaluation will be adjusted. Specifically, adjustments are made for the type of sound signals used for evaluation which are transmitted as well as for the reproduction time and overall adjustments are made so that the transmission time is shortened. Further, by predetermined time is meant the forced-termination decision time indicated in FIG. 2. The forced-termination decision time is set even prior to the completion of a single evaluation period in order to ensure the preparation time for the next speech quality evaluation.

Lastly, in Step S30, the speech quality evaluation value between: (1) the analog telephone terminal 110 and (2) the analog telephone terminal 150 is determined. The speech quality evaluation system 200 carries out a speech quality evaluation of a predetermined period of time according to: (1) a predetermined schedule and (2) preset operating procedures. For example, the speech quality evaluation system 200 can evaluate any changes in speech the quality of the call over a long period of time by repeatedly making speech quality evaluations for a predetermined period of time. In addition, when multiple sub-systems are deployed by decentralizing them at multiple points, the speech quality of a call among said multiple points can be evaluated by evaluating the speech quality of calls over a predetermined period of time while varying the combination of analog telephone terminals. Needless to say, evaluations can be made over long periods of time between each of the points. In the first embodiment of the present invention, a speech quality evaluation for a speech in the direction from the analog telephone terminal 110 to the analog telephone terminal 150 is carried out repeatedly, when the analog telephone terminal 110 originates a call-request and transmits sound signals and when the analog telephone terminal 150 accepts the call-request and receives the transmitted sound signals.

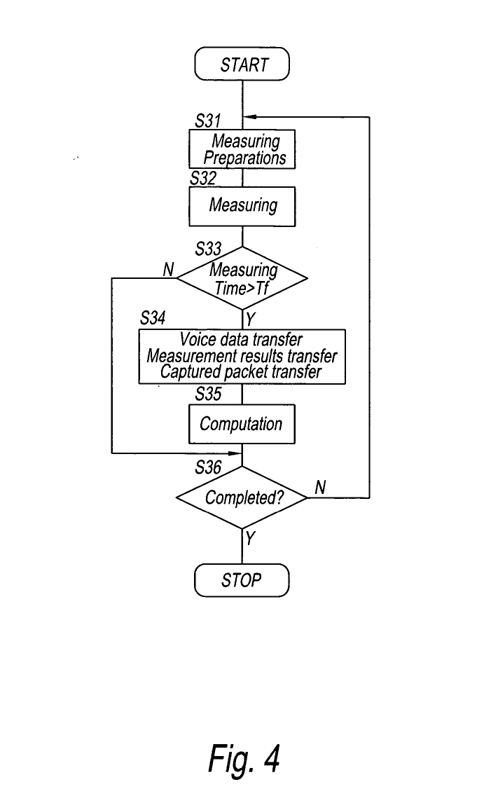

Here, we shall explain the speech quality evaluation for a predetermined period of time in Step S30 in greater detail. FIG. 4 is a flowchart which indicates the procedure for evaluating the speech quality of a telephone call.

First, in Step S31, the control unit 500 sets the operating procedure and the starting time for said procedure in the sound quality evaluation unit 310 via the monitor network 210.

Next, in Step S32, the sound quality evaluation unit 310 and the rest carry out the evaluation process according to the procedures set in these and according to the starting time for said procedure. First, a call-request is originated from the sound quality evaluation unit 310 and the call is set up between the sound quality evaluation unit 310 and the sound quality evaluation unit 410. Next, the sound quality evaluation unit 310 transmits sound signals to be evaluated and the loudness of the echo and the amount of circuit noise are measured. The sound quality evaluation unit 410 receives the sound signals used for evaluation which have become degraded in passing through the IP network 130 and stores them as sound data and the sound signals received are looped back to the sound quality evaluation unit 310. The sound quality evaluation unit 310 receives sound signals which are looped back from the sound quality evaluation unit 410 at the same time as transmitting the sound signals. The amount of delay measured in this case is the amount of sound delay which has made one round trip. The amount of one-way sound delay substitutes for half the value of the round-trip delay. The network analyzers 320 and 420 capture the respective packets and at the same time measure the throughput. At this time, the control unit 500 periodically checks the status of the sound quality evaluation unit 310 and the rest via the management network 210. Further, the mean value within a single evaluation period is measured for the loudness of the echo, the amount of circuit noise as well as the amount of sound delay. In addition, the mean value for the throughput is measured per unit hour. As a result, the throughput is measured multiple times within a single evaluation period and is stored in numeric array. Any setting can be made for the unit time according to the conditions of the IP network 130. It may be set, for example, to approximately 200 milliseconds.

Next, in Step S33, the measuring time is checked. By measuring time is meant the time from when the call-request originates from the sound quality evaluation unit 310 until the sound quality evaluation unit 310 the rest complete the measuring process. In this Step S33, when the measuring process using the sound quality evaluation unit 310 and the rest continues beyond the forced-termination decision time Tf indicated in FIG. 2, the control unit 500 carries out forced-termination of the measuring process using the sound quality evaluation unit 310 and the rest, the measure-disable flag goes on and we go on to the next step S36. When the measuring process carried out by the sound quality evaluation unit 310 and the rest is completed normally before it reaches the forced-termination decision time Tf, we go on to the next step S34. After the measuring process has been completed normally or after forced termination by the sound quality evaluation unit 310 and the rest, the call between the sound quality evaluation unit 310 and the sound quality evaluation unit 410 is released.

Next, in Step S34, the various data and measuring results are transmitted via the management network 210. This works specifically as follows: First, the data of the sound signals used for evaluation, which have been received by the sound quality evaluation unit 410 are transmitted to the sound quality evaluation unit 310. At this time, the sound quality evaluation unit 310 references the sound signal data which it has transmitted itself as well as the sound data which have been transmitted from the sound quality evaluation unit 410 and measures the clarity of the speech. Further, the mean value for this clarity of the speech is measured within a single evaluation period. Next, the measuring results for the clarity of the speech, the amount of sound delay, the loudness of the echo as well as the amount of circuit noise are sent from the sound quality evaluation unit 310 to the control unit 500. In addition, the results of measuring the throughput are also transmitted from the network analyzer 420 to the control unit 500. The respective packets which have been captured are transmitted from the network analyzers 320 and 420 to the control unit 500.

Next, in Step S35, the control unit 500 determines the amount of packet delay and the R-value by computation. The amount of packet delay is obtained by comparing the respective packets which have been captured by the network analyzers 320 and 420 for each packet. First, packets with the same sequence number inside the RTP header are selected from the packet which has been captured by the network analyzer 320 and the packet which has been captured by the network analyzer 420. In this case, if this involves an identifying number which can be used to select a transmission packet and the same receiving packet, another type of number may be used instead of the sequence number. Next, we compare the time stamps for the two packets which have been selected. The difference in time stamps at this time is the amount of packet delay. Further, the amount of packet delay for a packet loss is set a value which represents the error (for example, a negative value) or a value which represents infinite delay (for example, an extremely large value within a range which can be set). The amount of packet delay for each packet is determined and is stored in numeric array.

The R-value is calculated from the loudness of the echo, the clarity of the speech, the amount of sound delay and the amount of circuit noise which are measured by the sound quality evaluation unit 310 circuit noise, as well as the amount of packet delay which is obtained from the processing indicated above. The R-value involves a value—which changes according to changes in the amount of packet delay—which is calculated and is stored in numeric array. The results of measuring the clarity of the speech, the amount of sound delay, the loudness of the echo, the amount of circuit noise and the throughput are stored in the database 510 for each evaluation. The R-value and the amount of packet delay which are obtained by calculation and the captured packet are also stored in the database 510 for each evaluation.

Lastly, in Step S36, a determination is made as to whether the scheduled speech quality evaluation of the call has been completed or not. If the evaluation has been completed, we return to Step S31 and we continue processing. When we go on to the processing for Step S31, if the “measure disable” flag is on, we reduce the type of sound signals used for evaluation which make up the sound signals which are transmitted and we adjust the reproduction time for each of the signals used for evaluation use so that it is shorter, as was the case for the processing in Step S20. If the measuring results for a call between the same telephone terminals using adjusted sound signals satisfies the predetermined conditions and is completed, the sound signals are restored. For example, if measuring within forced-termination decision time Tf continues for at least two times, the sound signals are restored to a single echelon. Last of all, the “measure disable” flag goes off and we go back to Step S31.

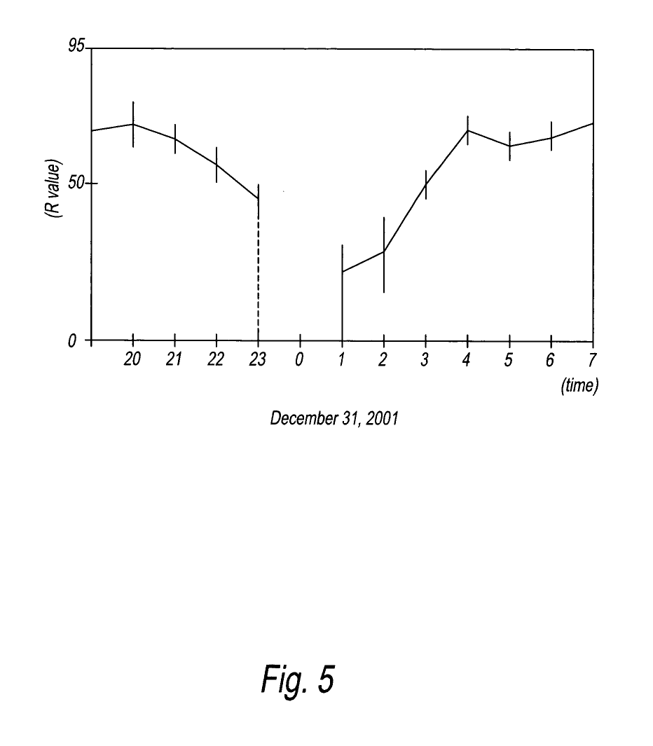

Here, we shall discuss how the results for the speech quality evaluation value of the call are displayed. The R-value which is stored in the database 510 is read in a procedure which is independent of the procedure going from Step S10 to Step S30 and it is output to the display unit (not shown in the figure) which has been provided in the control unit 500. A display example for the R-value is indicated in FIG. 5. In the graph in FIG. 5, the horizontal axis represents the time and the vertical axis is the R-value. The R-value becomes larger, the closer it is to the top of the vertical axis, and conversely becomes smaller, the closer it is to the bottom of the vertical axis. The horizontal axis displays not only the time but the date as well. The graph in FIG. 5 is used to plot the mean for the R-value for each evaluation period and it connects the points which are plotted on it. The Figure also contains vertical lines of different lengths. These vertical lines represent the amplitude of the fluctuations for the R-value within an evaluation period. The packet loss is expressed by the value at the very bottom of the graph. As a result, if there is even just one packet loss within the evaluation period in question, the vertical line which represents the amplitude of the fluctuations extends to the very bottom of the graph. In addition, when the R-value is not determined by forced completion of the measuring, the vertical line is not drawn and only points are plotted at the very bottom of the graph. Further, the number of evaluation periods which are the focus of the calculation of the mean value and the amplitude of the fluctuations are limited to one, and they change according to the time scale on the horizontal axis. The method of displaying the R-value in this way simultaneously provides information as to any general changes in the speech quality of the call and any problems which crop up suddenly and unexpectedly, so that it is suitable for IP telephone service use. Further, these display operations are based on a program which is executed using the control unit 500. The method which displays the mean value and the amplitude of fluctuations by overlapping them is also effective for other speech quality evaluation values which change in a time series. For example, this display method is extremely effective for displaying the clarity of the speech, the amount of sound delay or the amount of packet loss.

By the way, the general VoIP adapter drops a packet which arrives somewhat later than the prescribed time. In other words, a packet which arrives somewhat later than the prescribed time is the same as a loss packet for the VoIP adapter. For example, the amount of delay is different for a packet which arrives slightly later than the predetermined time and a packet which arrives substantially later than the predetermined time. The R-value which is calculated by referencing the respective amounts of delay is also different. However, both packets are canceled due to the VoIP adapter. The actual speech quality of the call is the same. As a result, the effect of the amount of packet delay must be the same as on the R-value. Therefore, we shall explain the second embodiment of the present invention which determines the amount of packet delay so that it conforms to the actual speech quality of the call.

The second embodiment of the present invention involves processing a packet with a delay which is greater than the predetermined time which is stipulated by the VoIP adapter on the receiving side according to the first embodiment of the invention, as loss packet. More specifically, the second embodiment of the invention is the speech quality evaluation system 200 operates according to the flowchart which Step 35 in FIG. 4 is replaced by Step 35a as follows.

Operations in Step S35a are carried out as follows: First, in Step S35a, the control unit 500 determines the packet delay and the R-value by calculating these values. The amount of packet delay is obtained by comparing the packets which have been captured respectively by the network analyzers 320 and 420 for each packet. First, packets with the same sequence number inside the RTP header are selected from the packet which has been captured by the network analyzer 320 and the packet which has been captured by the network analyzer 420. Next, the time stamps for the two packets selected are compared. The difference in time stamps at this time is the amount of packet delay. Further, when the packet delay is greater than the prescribed time which has been stipulated by the VoIP adapter 140, that packet is considered a loss packet and is handled as follows: The amount of packet delay for the packet loss is set the value which indicates the error (for example, a negative value) or the value which indicates an infinite delay (for example, a value that is too high within the parameters which can be set). The amount of packet delay for each packet is determined and stored in numeric array using the processing indicated above.

The R-value is calculated from the loudness of the echo, the clarity of the speech and the amount of sound delay and the amount of circuit noise which have been measured by the sound quality evaluation unit 310 as well as the amount of packet delay which has been obtained by using the processing indicated above. The R-value is such that the value which successively changes according to changes in the amount of packet delay is calculated and is stored in numeric array. The measuring results for the clarity of the speech, the amount of sound delay, the loudness of the echo, the amount of circuit noise as well as the throughput and the amount of packet delay obtained through calculation as well as the R-value and the captured packet are stored in the database 510 for each evaluation. This concludes the description of the operations in Step 35a.

Some VoIP adapters have functions which enable them to supplement the sound signals when a packet has been dropped or when a packet loss occurs. When the sound signals are supplemented, humans sometimes perceive virtually no deterioration in the speech quality of the call. Meanwhile, at this time, the worse R-value is sometimes obtained in a speech quality evaluation system in the first and second embodiments of the invention. Therefore, we shall explain a third embodiment of the invention which solves this problem as follows.

In the third embodiment of the invention, the payload of the packet according to the first embodiment of the invention is referenced and the sound signals are decoded according to the method of decoding used by the VoIP adapter on the receiving side. The amount of delay for each sound part is determined for the sound signals which have been decoded. More specifically, the third embodiment of the invention is the speech quality evaluation system operates according to the flowchart which Step 35 in FIG. 4 is replaced by Step 35b as follows.

Further, in this Specification, the method of decoding carried out by the VoIP adapter refers to a sound compression method, a packet dropping rule and other methods which relate to part or to all of the steps ranging from receiving the packet data by the VoIP adapter to generating the sound signals. By sound part of sound signals is meant a part wherein the power of the sound signals, the amplitude level or the signal-to-noise ratio exceeds a predetermined value and its status continues for a predetermined length of time. The predetermined value and the predetermined time are set so that a sound which is retrieved according to these conditional values can be identified as a meaningful sound by a human. For example, the prescribed time in this Specification is 0.1 second.

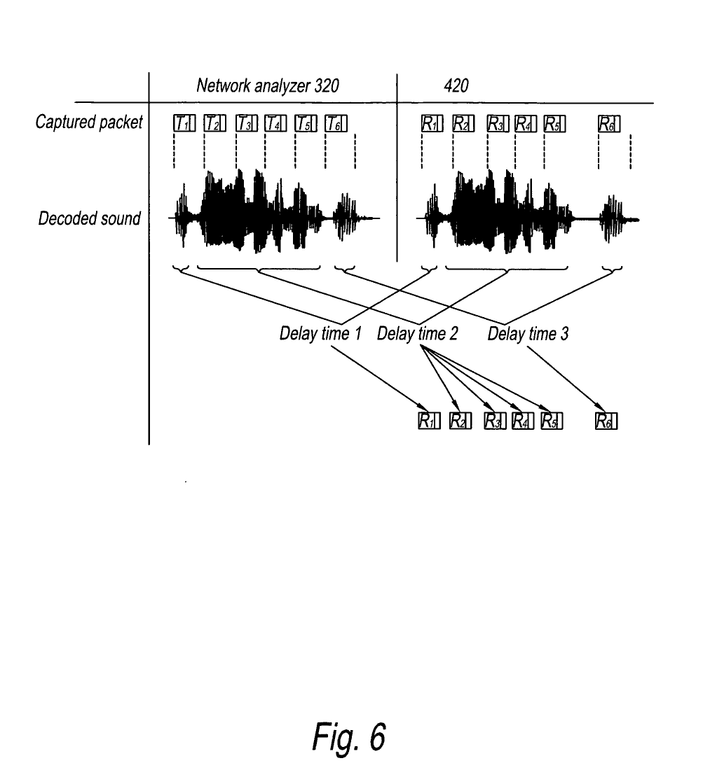

Operations for Step S35b are as follows. First, in Step S35b, the control unit 500 determines the amount of packet delay and the R-value by calculation. The amount of packet delay is obtained by referencing the payload of a packet and comparing the sound signals which have been decoded for each sound part. Here, we shall refer to FIG. 6. First, the payload of the packet is referenced for: (1) the respective packet T₆ from packet T₁ which has been captured by the network analyzer 320 and (2) the respective packet R₆ from packet R₁ which has been captured by the network analyzer 420, and the sound signals are decoded from the respective packet. The decoding process at this time is carried out according to the decoding method used by the VoIP adapter. Next, the sound part is retrieved for the respective sound signals which have been decoded according to the definition given above. When a non-sound part is included in the sound signals used for evaluation, at least two sound parts are retrieved from the decoded sound signals. Next, a search is made for a position which has a strong cross-correlation in order to compare the times in the sound parts. More specifically, (1) the sound part of a signal which has been decoded from a packet which has been captured by the network analyzer 320 and (2) the sound part of a signal which has been decoded from a packet which has been captured by the network analyzer 420 are compared. The position at which five consecutive bytes of sound signal data first coincide inside the respective sound parts is the representative position for the respective sound part. This representative position is such that a relative time vis-a-vis the beginning of the sound signals which have been decoded from a packet which is related to that position is determined uniformly according to number of bytes from the beginning of the decoded sound signals. Further, the time at the beginning of the sound signals which have been decoded from a packet which is related to the representative position is the time indicated by the time stamp for that packet. Lastly of all, the time for the representative position is compared and the amount of delay is determined. In FIG. 6, delay time 1, delay time 2 and delay time 3 are determined. Lastly, the amount of delay for each of the sound parts is the amount of delay for the respective related packets. In FIG. 6, delay time 1 is the amount of delay for packet R₁. Delay time 2 is the amount of delay for packet R₂ through packet R₅. Delay time 3 is the amount of delay for packet R₆. Further, when there is a defect in the sound signals which have been decoded from a packet which has been captured by the network analyzer 420 and comparison is not possible, the related packet is treated as a loss packet. The packet delay in this case is set the value which indicates the error (for example, a negative value) or a value which indicates an infinite delay (for example, a value that is too high within the parameters which can be set). The amount of delay for the packet is determined for each sound part and is stored in numeric array.

The R-value is calculated from the loudness of the echo, the clarity of the speech, the amount of delay in the sound and the circuit noise which are measured by the sound quality evaluation unit 310 as well as the amount of delay for the packet obtained from the aforementioned processing. Further, since the amount of delay in packets which correspond to the non-sound part is not determined, the R-value for non-sound part is not calculated either. The R-value is the value which is calculated, which changes in response to changes in the amount of delay for a packet and is stored in a numeric array. The results of measuring the clarity of the speech, the amount of sound delay, the loudness of the echo, the amount of circuit noise and the throughput are stored in the database 510 for each evaluation. The R-value and the amount of packet delay which are obtained by calculation and the captured packet are also stored in the database 510 for each evaluation. This explanation applies to the operations for Step 35b.

The evaluation results in the third embodiment of the present invention are displayed in virtually the same way as for the first embodiment of the invention. What is different is that the amplitude of fluctuations for the value R which is indicated in FIG. 5 applies only to the R-value for the sound part of the decoded sound.

The method for determining the delay for the packet in the third embodiment of the present invention makes it possible to determine the value which coincides with the actual speech quality of the call as compared to the method which simply measures each packet. As a result, the R-value is calculated a value close to the actual speech quality of a call.

Meanwhile, in the first through third embodiments of the present invention, the control unit 500 and the sound quality evaluation unit 310 and the rest are connected to a management network in order to transmit data and to control the units. In actuality, management network cannot always reach to a site where the sound quality evaluation unit 310 and the rest must be connected. For example, general consumers are not able to install a management network to evaluate speech quality of a call in their own homes. We will next explain a fourth embodiment of the present invention to resolve this problem.

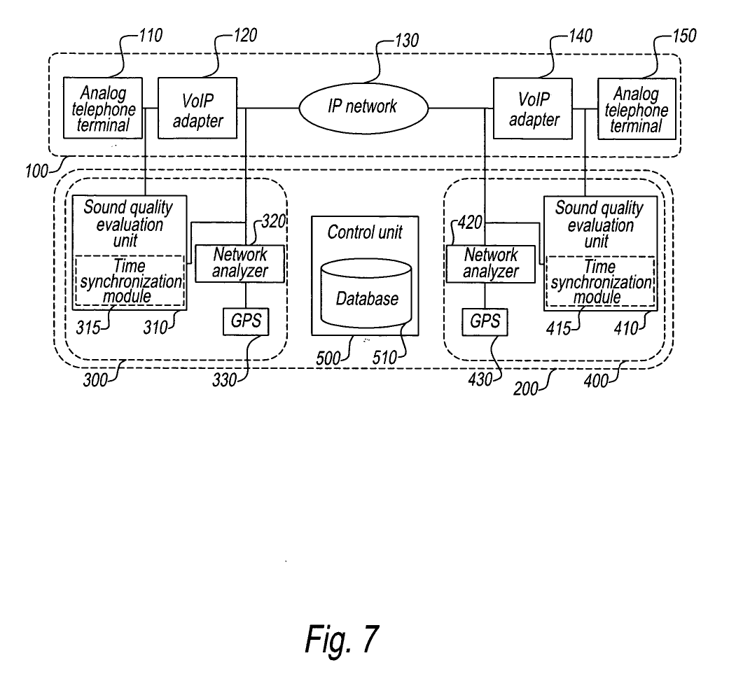

The fourth embodiment of the present invention is also a speech quality evaluation system. Its basic configuration is indicated in FIG. 7. In FIG. 7, the speech quality evaluation system 600 is provided with a sub-system 300 and a sub-system 400 similar to the speech quality evaluation system 200. The mode of connecting the speech quality evaluation systems 300 and 400 and telephone system 100 is almost the same. The only point on which it differs from the speech quality evaluation system 200 is that it does not have the management network 210 and the connections to the management network 210. In keeping with this, several operational changes are made for the speech quality evaluation system 600.

The speech quality evaluation system 600 which is configured as indicated above must determine the operating procedures for the system taking into consideration the transfer time for the captured packet which is carried out in Step S34 in FIG. 4. The transfer time for sound data and captured packets and the other types of data is a factor which shortens the measuring time.

In the fourth embodiment of the present invention, a packet which is captured by the network analyzers 320 and 420 is restricted to a packet which corresponds to the sound part of the sound signals. The sound signals which are transmitted by the sound quality evaluation unit 310 are series of different types of sound signals used for evaluation. Further, these sound signals used for evaluation are separated from one another by the non-sound sound signals in order to hold in check the effect of the echo. In addition, the sound signals used for evaluation consist of recorded conversations and are a mixture of sound parts and non-sound parts. As a result, if only a packet which corresponds to a sound part is captured, the amount of the packet which is transferred can be greatly reduced. If the transfer time is shortened, the measuring time within a single evaluation period can be greatly increased, forced-terminated evaluation can be greatly decreased in evaluation and the speech quality of the call can be evaluated more precisely.

In the fourth embodiment of the present invention, even if there is no transferred sound data and captured packets, the measuring results for the parameter which can be measured are transferred to the control unit 500. This is a more effective use than canceling the measurement results.

The speech quality evaluation value is obtained as follows: The amount of packet delay and the throughput are obtained as follows: The sound signals used for evaluation are transmitted from one sound quality evaluation unit. (1) A packet which corresponds to the sound signals transmitted and (2) a packet which corresponds to the sound signals used for evaluation which have become degraded while passing through the IP network 130 are captured by the network analyzers 320 and 420 and the sound signals which have been decoded from the packets which have been captured by the respective network analyzers are compared. The clarity of the speech is obtained as follows. Sound signals used for evaluation are transmitted from one sound quality evaluation unit and the sound signals used for evaluation which have passed through the IP network 130 are received at another sound quality evaluation unit and the sound signals transmitted and the sound signals received are compared. The amount of sound delay is obtained as follows: Sound signals used for evaluation are transmitted from one sound quality evaluation unit and the same sound signals which are looped back from another sound quality evaluation unit are received and the sound signals transmitted and the sound signals received are compared. The loudness of the echo is measured by transmitting sound signals used for evaluation from one sound quality evaluation unit and are measured by the same sound quality evaluation unit. The R-value is found by calculating from the clarity of the speech and the amount of packet delay which were obtained above.

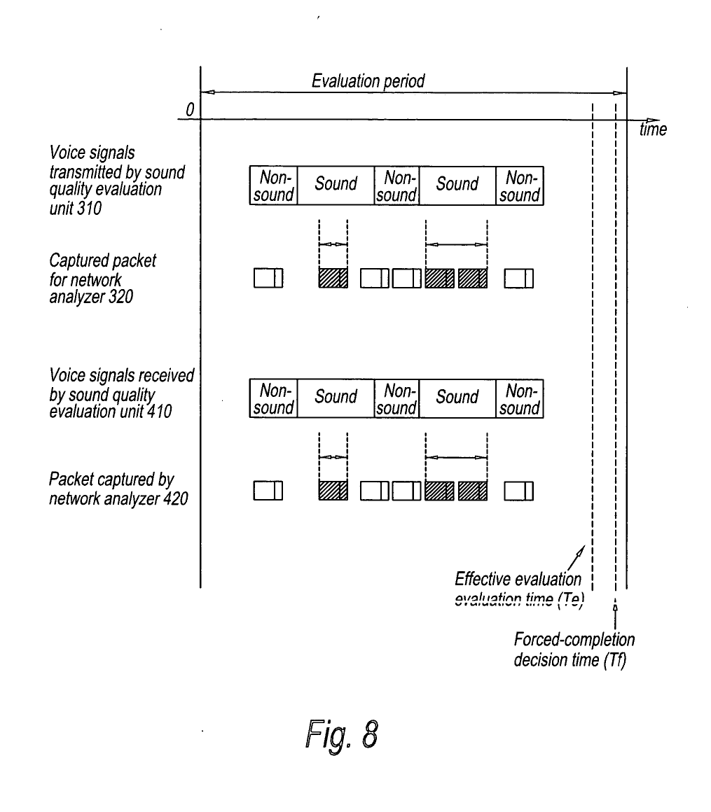

FIG. 8 indicates the time relationship between the sound signals which are transmitted and the sound signals which are received and the packets which are captured. Wherein the sound signals are transmitted from the sound quality evaluation unit 310 and received by the sound quality evaluation unit 410 in FIG. 7.

FIG. 8 indicates, in the following order, the sound signals which are transmitted by the sound quality evaluation unit 310, the packets which have been captured by the network analyzer 320, the sound signals which have been received by the sound quality evaluation unit 410 and the packets which have been captured by the network analyzer 420. These sound signals and packets relate to a single conversation which is carried out within a single evaluation period. In addition, the transmission and receiving of the sound signals and the capturing of the packets start and are completed within a predetermined evaluation period. Further, of the vertical solid lines in the figure, the solid line on the left indicates the starting time for a single evaluation while the solid line on the right indicates the completion time for the same evaluation period.

The sound signals which are transmitted from the sound quality evaluation unit 310 are transmitted at somewhat of a delay from the time the evaluation starts. This happens because the sound signals are transmitted after the call between the sound quality evaluation unit 310 and the sound quality evaluation unit 410 has been set up. In addition, the sound signals which are transmitted are made up of at least one type of sound signals used for evaluation and should preferably be configured of a series of different types of sound signals used for evaluation. Further, those sound signals used for evaluation are separated from one another by sound signals with non-sound in order to hold in check the effect of the echo. As a result, the sound signals which are transmitted from the sound signal evaluation unit 310 are a mixture of sound parts and non-sound parts. The sound signals used for evaluation include a recorded conversation and may be a mixture of sound parts and non-sound parts. After the sound signals have been transmitted (not shown in figure), the sound quality evaluation unit 310 releases the call.

The sound signals which are received by the sound signal evaluation unit 410 are transmitted from the sound quality evaluation unit 310 and are sound signals which have deteriorated by passing through the IP network 130. In addition, the sound signals which have been received start to be received at somewhat of a delay from the beginning of the evaluation. As indicated previously, this happens because the sound signals are transmitted after the call has been set up. Further, the beginning of the sounds which are received contains a small non-sound part. The sound signals which are transmitted from the sound evaluation unit 310 reach the sound quality evaluation unit 410 with a slight delay.

A packet which has been captured by the network analyzer 320 corresponds to the sound part of sound signals which are transmitted from the sound quality evaluation unit 310. More specifically, a packet which has been captured is an RTP (Realtime Transport Protocol) which is restricted by the IP address of a VoIP adapter 120 and the IP address of a VoIP adapter 140 and is captured within a predetermined period of time. In FIG. 8, the packets which have been captured are indicated by diagonal lines. Further, the unpatterned packets are packets which are not associated with the sound signals such as control packet and are not captured. In addition, for the sake of convenience, we will say that there are seven packets which correspond to the sound signals which are transmitted by the sound quality evaluation unit 310. Needless to say, there may actually be many more packets.

A packet which has been captured by the network analyzer 420 is a packet which corresponds to the sound part of sound signals which are received by the sound quality evaluation unit 410. More specifically, a packet which has been captured is an RTP packet which is restricted by an IP address of the VoIP adapter 120 and an IP address of a VoIP adapter 140 and is captured within a predetermined period of time. In FIG. 8, packets which have been captured are indicated by diagonal lines. Further, the unpatterned packets are packets which are not associated with the sound signals such as control packet and are not captured. In addition, as was the case above, there are seven packets which correspond to the sound signals which are received by the sound quality evaluation unit 410.

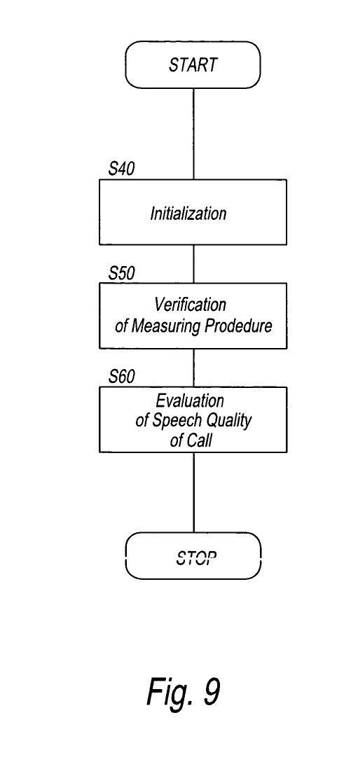

Next, we shall explain the operating procedures for the speech quality evaluation system 600. Here, FIG. 9 is a schematic flowchart indicating the operations for the speech quality evaluation system 600. Further, these operations are carried out on a program which is executed in the control unit 500.

First, in Step S40, the control unit 500 carries out initialization for the sound quality evaluation unit 310 and the rest. For example, the control unit 500 is used to set telephone numbers and IP addresses and the other parameters for the sound quality evaluation units 310 and 410.

Next, in Step S50, the operating procedures which are set in the sound quality evaluation unit 310 and the rest are carried out on a test basis. Verification is made to see whether a single speech quality evaluation is being completed within the predetermined period of time, the sound signals used for evaluation are adjusted as needed and an overall adjustment is carried out so that the transmission time is shortened. Specifically, adjustments are made for the type of signals use for evaluation which are transmitted and the reproduction time for each of the signals used for evaluation. Further, by predetermined time is meant the effective evaluation time Te indicated in FIG. 8. The effective evaluation time is set before one evaluation period is completed so that transfer time for the measurement results and transfer time for the captured packets as well as the preparation time for the next speech quality evaluation can be ensured. In addition, the time zone wherein a packet is captured by the network analyzers 320 and 420 is determined in this step. Specifically, this procedure is conducted as follows. First, a check is made to determine the time zone in the evaluation period in which a sound part is present in the sound signals transmitted by the sound quality evaluation unit 310 when the sound signals used for evaluation are adjusted so that one speech quality evaluation is completed within a specified period of time. Next, the starting time is delayed for several 500 milliseconds in the respective time zones of the sound part and the completion time is accelerated 500 milliseconds. The time zone which has been obtained as the result is made into the time zone wherein the packet is captured by the network analyzer 320. Likewise, when the sound signals used for evaluation are adjusted so that one speech quality evaluation is completed within the prescribed period of time, a check is made to determine the time zone in the evaluation period in which the sound part is present in the sound signals transmitted by the sound quality evaluation unit 310. Next, the starting time for the respective time zones for the sound part is delayed 500 milliseconds and the completion time is accelerated 500 milliseconds. The time zone which is obtained as the result is the time zone wherein a packet is captured by the network analyzer 420. Thus, the reason for shortening the time zone for the sound part is to provide for the time up until the sound signals become stable. Another reason is to avoid the effect of the maximum permissible delay between terminals for the IP telephone service and to ensure that the packet which corresponds to the sound part is captured. Further, the time shortened is not restricted to 500 milliseconds and is set as appropriate depending on the specifications for the IP telephone service.

Lastly, in Step S60, the speech quality evaluation value between the analog telephone terminal 110 and the analog telephone terminal 150 is determined. As was the case in Step 30, the speech quality evaluation system 200 evaluates the speech quality of a call for a predetermined length of time according to a predetermined schedule and preset operating procedures. In making this speech quality evaluation, the R-value and the amount of packet delay and the like are obtained by carrying out the series of procedures indicated below.

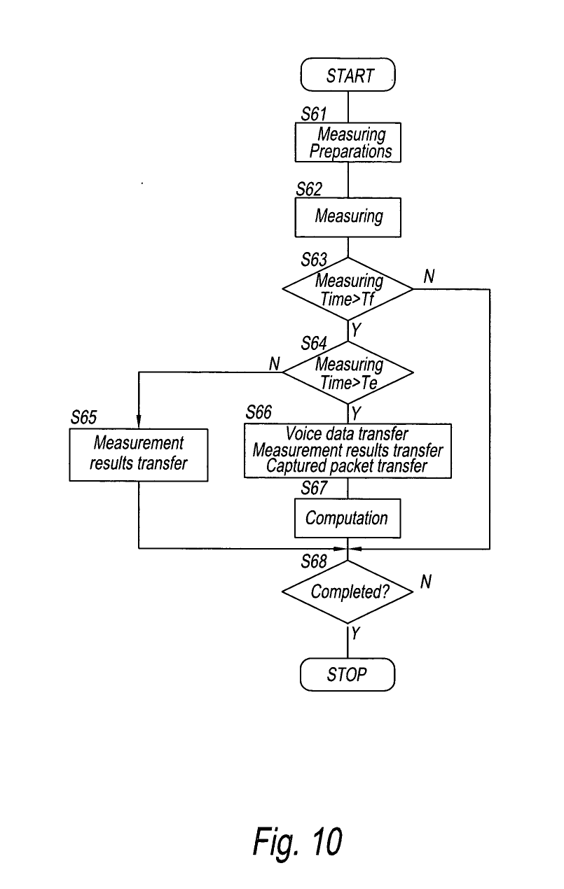

Next, we shall describe in detail the procedures involved in making the speech quality evaluation in Step S60. FIG. 10 is a flowchart which indicates the detailed procedures for this.

First, in Step S61, the control unit 500 sets the measuring procedures and the starting time for these procedures in the sound quality evaluation unit 310 and the rest via the IP network 130. The measuring start time for the sound quality evaluation units 310 and 410 are predetermined. A time zone wherein a packet is captured by network analyzers 320 and 420 are determined in Step S50.

Next, in Step S62, the sound quality evaluation unit 310 and the rest carry out the measurement according to a procedure which has been set in these units and according to the starting time for said procedure. First, the sound quality evaluation unit 310 originates a call request and the call is set up between the sound quality evaluation unit 310 and the sound quality evaluation unit 410. Next, the sound quality evaluation unit 310 transmits sound signals used for evaluation and at the same time measures the loudness of the echo and the extent of the circuit noise. The sound quality evaluation unit 410 receives the sound signals used for evaluation which have deteriorated passing through the IP network 130 and stores them as sound data. At the same time, the sound signals which have been received are looped back to the sound quality evaluation unit 310. The sound quality evaluation unit 310 receives sound signals which have been looped back from the sound quality evaluation unit 410 at the same time that the sound signals are transmitted and the amount of sound delay is measured. The amount of delay which is measured in this case is the amount of round-trip sound delay. The amount of one-way sound delay substitutes for the half-value of the round-trip sound delay. The network analyzers 320 and 420 capture the respective packets and at the same time measure the throughput. At this time, the control unit 500 periodically checks the status of the sound quality evaluation unit 310 and the rest. Further, the mean values for the loudness of the echo, the amount of circuit noise and the amount of sound delay are measured within a single evaluation period. In addition, the mean value for the throughput is measured per unit hour. As a result, the throughput is measured multiple times in a single evaluation period and is stored in numeric array. Any setting may be made for the unit hour according to the conditions of the IP network 130. It may be set, for example, to approximately 200 milliseconds.

Next, in Step S63, the measuring time is checked. The measuring time is the time from the start of a call originating from the sound quality unit 310 up to the time that measurement using for the sound quality evaluation unit 310 the rest is completed. Specifically, when measuring for the sound quality evaluation unit 310 and the rest continues beyond the forced-termination decision time Tf indicated in FIG. 8, and the control unit 500 forces to terminate the measuring of the sound quality evaluation unit 310 and the rest, the “measure disable” flag goes on and we go on to Step S68. When measuring using the sound quality evaluation unit 310 and the rest is completed normally before reaching the forced-termination decision time Tf, we go on to the processing in Step S64. After the measurement with the sound quality evaluation unit 310 and the rest has been completed, either normally or after forced completion of the measurement has occurred, the call between the sound quality evaluation unit 310 and the sound quality evaluation unit 410 is released.

Next, in Step S64, the normally completed measuring time is checked. By measuring time is meant the time from the start of the call-request originated by the sound quality evaluation unit 310 up to the time that measurement using the sound quality evaluation unit 310 and the rest has been completed. Specifically, when the measuring time for the sound quality evaluation unit 310 and the rest has continues beyond the effective evaluation time Te indicated in FIG. 8, the “measuring invalid” flag goes on, and we go on to Step S65. When the measuring time for the sound quality evaluation unit 310 and the rest does not continues beyond the effective evaluation time Te indicated in FIG. 8, we go on to Step S66.

In Step S65, the measuring results are transmitted via IP network 130. Specifically, the measurement results including the amount of sound delay, the extent of echo and the amount of circuit noise are sent from the sound quality evaluation unit 310 to the control device 500. In addition, the throughput measuring results are sent from the network analyzer 420 to the control unit 500.

In Step S66, a variety of data and measuring results are transmitted via the IP network 130. Details of this are as follows: First, the data for sound signals used for evaluation which are received by the sound quality evaluation unit 410 are transmitted to the sound quality evaluation unit 310. At this time, the sound quality evaluation unit 310 measures the clarity of the speech referencing the sound signals which it has transmitted and the sound data which have been transmitted from the sound quality evaluation unit 410. Next, measuring results such as the clarity of the speech, the amount of sound delay, the extent of echo and the amount of circuit noise are sent from the sound quality evaluation unit 310 to the control unit 500. In addition, the various packets which have been captured are sent from the network analyzers 320 and 420 to the control unit 500.

In Step S67, the control unit 500 determines the packet delay and the R-value by computing. The packet delay is obtained by referencing the payload of the packet and comparing the sound signals which have been decoded. First, the packet payload is referenced and the sound signals are decoded for the respective packets which have been captured by the network analyzer 320 and the packets which have been captured by the network analyzer 420. Decoding at this time is carried out according to the method of decoding for the VoIP adapter 140. Since the capture time zone for the packet is adjusted beforehand, only the sound parts for the sound signals used for evaluation are captured. However, a non-sound part may arise in a decoded sound due to a packet loss and a large packet delay. Therefore, the distribution of the sound part and the non-sound part is checked for the respective decoded sound signals and only the sound part is retrieved. Further, if there are multiple non-sound parts in these sound signals, the sound parts are retrieved individually. Next, a search is made for a position with a strong cross-correlation and this is used to compare the time for each sound part. These operations can determine or “indicate the beginning” of the reference position for making the comparison. Specifically, (1) the sound part of the sound signals which have been decoded from the packet which was captured by the network analyzer 320 and (2) the sound part of the sound signals which have been decoded from the packet which was captured by the network analyzer 420 are compared. The position at which 5 consecutive bytes of sound signal data in the respective sound parts first coincide is the representative position for the respective sound parts. This representative position is such that the relative time referred to the beginning of the sound signals decoded from a packet which relates to that position is determined uniformly according to the number of bytes from the beginning of the decoded sound signals. Further, the time of the beginning of the sound signals which have been decoded from a packet which is related to a representative position is the time indicated by the time stamp for that packet. Lastly, the time for the representative position is compared for each sound part, to determine the amount of delay. The amount of delay for each of the sound parts is the amount of delay for the respective related packets. Further, when there are deficiencies in the sound signals decoded from a packet which has been captured by the network analyzer 420 and comparison is not possible, the related packet is treated as a loss packet. The amount of packet delay in that case is the value (for example, a negative value) which indicates an error or a value (for example, a value which is too high within the parameters which can be set) which represents an infinite delay. According to the processing indicated above, the amount of packet delay is such that the value for each sound part is determined and is stored in numeric array.

The R-value is calculated from the loudness of the echo, the clarity of the speech and the amount of sound delay and the amount of circuit noise which are measured by the sound quality evaluation unit 310 as well as the amount of packet delay which has been obtained using the processing mentioned above. The R-value successively changes according to the changes in the amount of packet delay and is stored in numeric array. The amount of packet delay, the R-value and the packets captured have been obtained from the results for measuring the clarity of the speech, the amount of sound delay, the loudness of the echo, the amount of circuit noise and throughput computations and are stored in the database 510 for each evaluation.

Lastly, in Step S68, it is determined whether the scheduled speech quality evaluation has been completed. If the evaluation has not been completed, we return to Step S61 and continue processing. When proceeding to the processing in Step S61, if the “measuring invalid” flag goes on, the types of signals used for evaluation which make up the sound signals transmitted are reduced and the reproduction time for each of the signals used for evaluation is adjusted so that it is shortened. These sound signals which have been adjusted are such that if measuring between the same telephone terminals using adjusted sound signals satisfies the predetermined conditions and the measuring is completed, the sound signals are restored. For example, if completed measuring within the effective evaluation time Te is continued for at least two times, the sound signals are returned one echelon. Last of all, the “measuring invalid” flag goes off and we go back to Step S61. In addition, even if the “measure disable” flag goes on, the sound signals are adjusted in the same way, the “measure disable” flag goes off and we go back to Step S61. When the “measure disable” flag goes on, the measuring time should be adjusted so that it is shorter than the time when the “measuring invalid” flag goes on.

The results in the fourth embodiment of the present invention are displayed in much the same way as the first embodiment of the invention. The point which differs is that the margin of fluctuation in the R-value which is indicated in FIG. 5 focuses only on the R-value for the sound part in the decoded sounds.

Further, in the fourth embodiment of the present invention, the amount of packet delay may be found by comparing the packet units as in the first embodiment of the present invention. The amount of packet delay may also be found by processing a packet with a greater amount of delay than the predetermined time as a loss packet and then comparing it in packet units, as indicated in the second embodiment of the present invention. When the aforementioned changes are carried out, the results are displayed according to the method or procedure indicated in the respective embodiment examples of the invention.

Next, we shall describe a fifth embodiment of the present invention such that its elements can be specified when the speech quality of the call has become degraded. The fifth embodiment of the present invention is likewise a speech quality evaluation system. Its configuration is the same as the speech quality evaluation system 600 indicated in FIG. 7. A schematic view of its operations is also indicated in FIG. 9. However, there are some differences from the procedures indicated in FIG. 10.

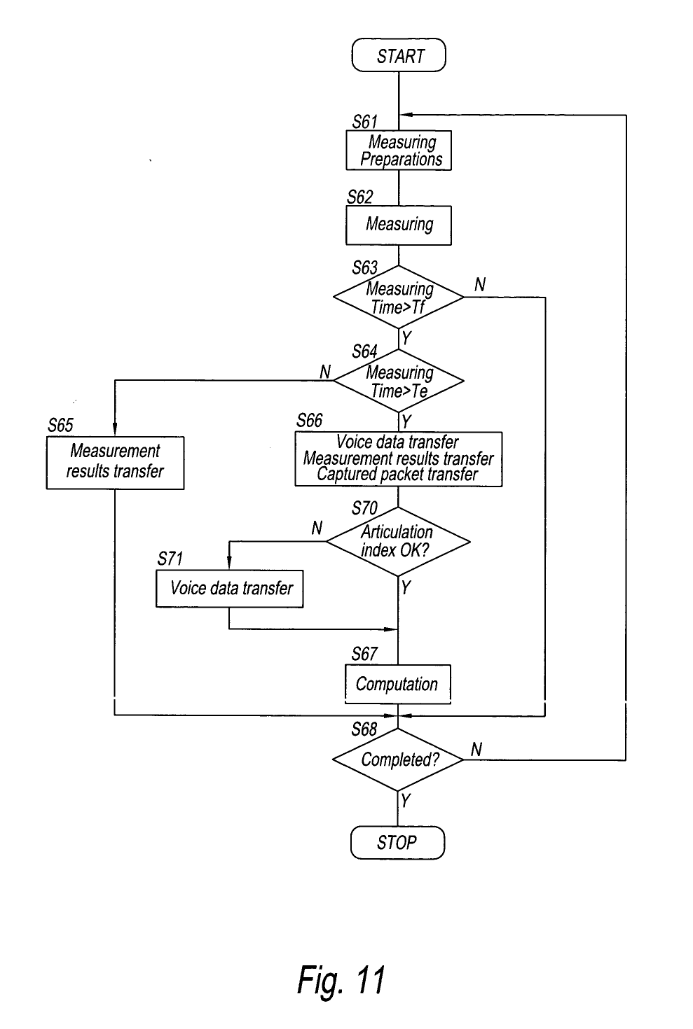

FIG. 11 is a flowchart which indicates the procedure for speech quality evaluation in the fifth embodiment of the present invention. It is different from the flowchart indicated in FIG. 10 in that new step, i.e., Step S70 and Step S7, have been added. The operations in the other steps are the same as the steps indicated in the flowchart in FIG. 10 by the same numbers.

In Step S70, the control unit 500 checks the clarity of the speech which has been measured by the sound quality evaluation unit 310. When the clarity of the speech is superior to the predetermined value, we go on to Step S67. However, when the clarity of the speech is inferior to the predetermined value, we go on to Step S71.

In Step S71, the sound signals transmitted by the sound quality evaluation unit 310 and the sound signals received by the sound signal evaluation unit 410 are transmitted as sound data to the control unit 500 and are stored in the database 510. Further, in the speech quality evaluation system 600, the time at which the sound data are transmitted to the control unit 500 is again required as indicated above and the effective evaluation time Te is set so that it precedes the time in case of the fourth embodiment of the present invention.

Step S70 and Step S71 need not come just between Step S66 and Step S67 but may come between Step S67 and Step S68. In other words, when the clarity of the speech has been found to be degraded, the sound data should be kept until the next evaluation starts.

In the speech quality evaluation system 600, the parameters are set anew to specify the factors involved in the degradation of the speech quality of the call. These parameters are amount of delay in three sections: (1) between the IP network 130 connection terminal for the analog telephone terminal 120 and the VoIP adapter 120 (hereinafter “Section 1”); (2) between the VoIP adapter 120 and VoIP adapter 140 (hereinafter Section 2″); and (3) between the IP network 130 connection terminal for the VoIP adapter 140 and the analog telephone terminal 150 (hereinafter Section 3″).

Next, we shall describe the procedures for measuring the amount of delay in these three sections. These measuring procedures may be carried out independently of the procedures indicated in FIG. 9 and FIG. 10.

First, the amount of delay in Section 1 is determined by comparing (1) the sound signals which are transmitted by the sound quality evaluation unit 310 and (2) the sound signals which are decoded from the data inside the payload in the packet which has been captured by the network analyzer 320. Decoding at this time is carried out according to the decoding method carried out by the VoIP adapter 140. The amount of delay in this case is determined as follows:

First, the sound signals are decoded by referencing the payload of the packet for the packet which has been captured by the network analyzer 320. Decoding at this time is carried out according to the decoding method used by the VoIP adapter 140. Next, we studied the distribution of the sound part and the non-sound part for the sound signals transmitted by the sound quality evaluation unit 310 and for the decoded sound signals and retrieved only the sound part. Further, if there are multiple sound parts in these sound signals, said sound parts are retrieved separately. Next, we searched for a position where there was a strong cross-correlation and determined it in order to compare the time for each sound part. These operations can be thought of as determining or “indicating the beginning” of the reference position for making the comparison. Specifically, (1) the sound part for the sound signals which are transmitted by the sound quality evaluation unit 310 and (2) the sound part for the sound signals which have been decoded from a packet captured by the network analyzer 320 are compared. The position at which the data for five consecutive bytes of sound signals in the respective sound parts first coincide is the representative position for the respective sound parts. The representative position for the sound part in the sound signals which are transmitted by the sound quality evaluation unit 310 is such that the relative time vis-a-vis the beginning of the transmitted sound signals is determined uniformly depending on the number of bytes from the beginning of the sound signals relative to that position. Further, the time at the beginning of the sound signals which have been transmitted by the sound quality evaluation unit 310 is the transmission starting time for the sound signals. The representative position for the sound part in the sound signals which have been decoded from a packet related to that position is such that the relative time vis-a-vis the beginning of the decoded sound signals is determined uniformly depending on the number of bytes from the beginning of the decoded sound signals. Further, the time at the beginning of the sound signals which have been decoded from a packet which is related to the representative position is the time indicated by the time stamp for that packet. Last of all, the time of the representative position is compared and the amount of delay is determined for each sound part. Further, if there is a deficiency in the sound signals which have been decoded from a packet which has been captured by the network analyzer 320 and a comparison cannot be made, the related packet is treated as a loss packet. The amount of in that case is set a value which indicates an error (for example, a negative value) or a value which represents infinite delay (for example, a value that is too high for the range which can be set). The amount of delay is determined for each sound part and is stored in numeric array.

The amount of delay in Section 2 is determined by comparing: (1) the sound signals which have been decoded from the data inside the payload of a packet which has been captured by the network analyzer 320 and (2) the sound signals which have been decoded from the data inside the payload of a packet which has been captured by the network analyzer 420. Decoding at this time is likewise carried out according to the decoding method carried out by the VoIP adapter 140. Determining the amount of delay in this case is carried out as follows:

The amount of delay is obtained by referencing the payload of a packet and comparing the sound signals which have been decoded for each sound part. First, the payload of a packet is referenced for the respective packets for: (1) a packet which has been captured by the network analyzer 320 and (2) a packet which has been captured by the network analyzer 420 and the sound signals are decoded. Decoding at this time is carried out according to the method used by the VoIP adapter 140. The capturing time zone for a packet is adjusted beforehand so that only the sound part of the sound signals used for evaluation are captured. However, a non-sound part can occur in a decoded sound due to packet loss and extensive packet delay. Then, the distribution of the sound part and the non-sound part for the respective sound signals which have been decoded are studied and only the sound part is retrieved. Further, if there are multiple sound parts in these sound signals, the sound parts are retrieved separately. Next, a search is made for a position with a strong cross-correlation and this position is determined in order to compare the time for each sound part. These operations can be called determining or “indicating the beginning” of the reference position for making the comparison. Specifically, (1) the sound part of signals which have been decoded from a packet captured by the network analyzer 320 and (2) the sound part of signals which have been decoded from a packet captured by the network analyzer 420 are compared. Then, the position at which the data consisting of five consecutive bytes of sound signals inside the respective sound parts first coincide is the representative position for the respective sound parts. The representative position is such that the relative time referred to the beginning of the sound signals which have been decoded from a related packet relating to that position is determined uniformly by the number of bytes from the beginning of the decoded sound signals. Further, the time at the beginning of the sound signals which have been decoded from a packet relating to the representative position is the time indicated by the time stamp for that packet. Last of all, the time for the representative position is compared and the amount of delay is determined for each sound part. Further, if there are deficiencies in the sound signals which have been decoded from a packet which has been captured by the network analyzer 420 and comparison cannot be carried out, the related packet is treated as a loss packet. The amount of packet delay in that case is set a value which indicates an error (for example, a negative value) or a value which indicates infinite delay (for example, a value that is too high within the parameters which can be set). The amount of packet delay is such that a value for each sound part is determined and is stored in numeric array using the aforementioned processing.

The amount of delay in Section 3 is determined by comparing: (1) the sound signals which have been decoded from data inside the payload of a packet which has been captured by the network analyzer 420 and (2) the sound signals which have been received by the sound quality evaluation unit 410. Decoding at this time is likewise carried out according to the decoding method used by the VoIP adapter 140. Determining the amount of delay in this case is carried out as follows:

First, the payload of a packet which has been captured by the network analyzer 420 is referenced and the sound signals are decoded. Decoding at this time is carried out according to a decoding method used by the VoIP adapter 140. Next, the distribution of the sound part and the non-sound part is checked for sound signals which have been decoded and for sound signals which have been received by the sound quality evaluation unit 410 and only the sound part is retrieved. Further, if there are multiple sound parts in these sound signals, the sound parts are retrieved individually. Next, a search is made for a position with a strong cross-correlation in order to compare the time for each sound part. These operations can be called determining or “indicating the beginning” of the reference position to carry out the comparison operations. Specifically, (1) the sound part of the sound signals which have been received by the sound quality evaluation unit 410 and (2) the sound part of the signals which have been decoded from a packet captured by the network analyzer 420 are compared. Then, the position at which five consecutive bytes of sound signal data inside the respective sound parts first coincide is considered the representative position for the respective sound parts. The representative position for a sound part in sound signals which are received by the sound quality evaluation unit 410 is such that the relative time referred to the beginning of the received sound signal is determined uniformly according to the number of bytes from the beginning of the received sound signals relating to that position. Further, the time of the beginning of the sound signals which have been received by the sound quality evaluation unit 410 is the time at which the sound signals start to be received. In addition, the representative position for the sound part in the sounds signals which have been decoded from a packet relating to that position is such that the relative time vis-a-vis the beginning is determined uniformly depending on the number of bytes from the beginning of the sound signals. Further, the time at the beginning of the sound signals which have been decoded from a related packet at a representative position is the time indicated by the time stamp for that packet. Lastly, the time for the representative position is compared for each sound part, to determine amount of delay. Further, if there are defects in the sound signals which have been received by the sound quality evaluation unit 410 and a comparison cannot be carried out, the related packet is treated as a loss packet. The amount of packet delay in this case is set a value which indicates an error (for example, a negative value) or a value which indicates an infinite delay (for example, a value that is too high within parameters that can be set). The amount of packet delay is determined and is stored in numeric array according to the processing indicated previously.

Sound signals and packets which are used to determine the amount of delay as indicated above are stored in the database 510 and referenced.

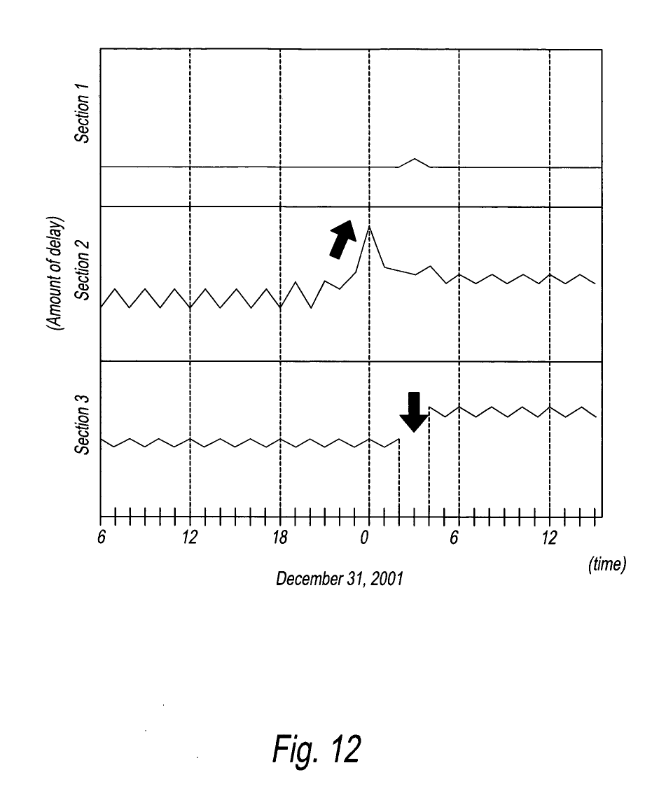

The respective amounts of delay which are found using the processing indicated above are output to the display unit (not shown in figure) of the control unit 500. An output example of this is indicated in FIG. 12. In the three graphs in FIG. 12, the horizontal axis indicates time and the vertical axis indicates the amount of delay. The horizontal axis indicates not only time but the date as well. The delay is larger towards the upper part of the vertical axis and conversely is smaller towards the bottom. The topmost graph indicates the amount of delay between the analog telephone terminal 120 and the IP network 130 connection terminal for the VoIP adapter 120. The graph in the middle indicates the amount of delay between the VoIP adapter 120 and the VoIP adapter 140. The graph at the bottom indicates the amount of the delay between the IP network 130 connection terminal for the VoIP adapter 140 and the analog telephone terminal 150. In each graph, if there are defects in the sound signals to be received and the packets to be received, then these are plotted at the very bottom of the graph. Further, the aforementioned operations which have been added in the fifth embodiment of the present invention are carried out according to a program which is executed in the control unit 500.

According to the graph which is displayed as indicated above, sections are specified which cause the speech quality of the call to become degraded. For example, within a certain same time frame, sections containing (1) defective sound signals to be received and (2) defective packets are assumed to be sections which are factors in causing the speech quality of a call to become degraded. In addition, within a certain same time frame, the sections with the greatest rate of increase in the amount of delay are also assumed to be sections which are factors in causing the speech quality of a call to become degraded. Thus, the speech quality evaluation system 600 in the fifth embodiment of the present invention determines the amount of delay and defectiveness in the respective sections—at a time in which the connection between the telephone terminals has been split into multiple sections—and displays these so that the speech quality of a call can be evaluated and troubleshooting is possible as well. In addition, the trend for R-value or the trend for the clarity of the speech are normally displayed as indicated in FIG. 5. When the user clicks on the location where the R-value or the clarity of the speech has become degraded so that the graph indicated in FIG. 12 is displayed, the user can go immediately from using the system to troubleshooting. Thus, the speech quality evaluation system 600 is a system which is all the more attractive for the IP telephone service provider.

Further, in the fifth embodiment of the present invention, the sound signals which have been transmitted by the sound quality evaluation unit 310 are sent to the control unit 500 as sound data. This occurs because the sound signals used for evaluation are adjusted as is appropriate in the speech quality evaluation system 600 and are not constant. However, the transfer time for the sound data puts pressure on the measuring time and should be kept as short as possible. Therefore, the sound quality evaluation unit 310 and the control unit 500 have in advance sound signals used for evaluation in multiple patterns which have been numbered. Thus, in Step S71, only the number assigned to the sound signals which have been transmitted by the sound quality evaluation unit 310 should be transmitted to the control unit 500. This numbering is effective in other embodiments of the present invention wherein the data transfer occurs in order to check the sound signals used for evaluation which have been transmitted.

The speech quality evaluation system in the present invention is used to evaluate the quality of a speech (or a call) in a direction from the analog telephone terminal 110 to the analog telephone terminal 150. In general, the quality of a call must be evaluated for both directions. When the quality of a call originating from the analog telephone terminal 150 to the analog telephone terminal 110 is being evaluated, it should be carried out by an procedure which replaces the sub-system 300 and the sub-system 400. For example, Step S32 previously mentioned is carried out using the following procedure: First, the sound quality evaluation unit 410 originates a call-request and the call is set up between: (1) the sound quality evaluation unit 310 and (2) the sound quality evaluation unit 410. Next, the sound quality evaluation unit 310 transmits sound signals to be used for evaluation. At the same time, the loudness of the echo and the amount of circuit noise are measured. The network analyzers 320 and 420 capture the respective packets and at the same time measure the throughput. In addition, the measuring of the amount of sound delay for the sound quality evaluation unit 410 and the loop back for the sound quality evaluation unit 310 overlap with the speech quality evaluation in the opposite direction and may be omitted. Even in the other steps, it is possible to make the same substitution and omission. Further, the quality evaluation procedures of a speech in a direction from the analog telephone terminal 110 to the analog telephone terminal 150 and the speech quality evaluation procedures for calls originating from the analog telephone terminal 150 to the analog telephone terminal 110 may be carried out in the same evaluation period and may be carried out separately.

In addition, the speech quality evaluation system in the present invention may be used to successively change the combinations of telephone terminals to be evaluated and to evaluate the quality of the calls. In this case, the sub-system is installed at many different points. Units with analytical functions are oftentimes expensive and if these units are installed at many different points, the overall cost of the speech quality evaluation system is increased. In order to solve this problem, the speech quality evaluation system in the present invention can evaluate the quality of calls by using a packet capturing unit instead of a network analyzer and by using a sound signal sending and receiving unit instead of a sound quality evaluation unit. For example, at least one sub-system which is equipped with a network analyzer and a sound quality evaluation unit may be installed and multiple sub-systems which are equipped with a packet capturing unit and a sound signal receiving unit may be installed. Then, the evaluation schedule is integrated so that a unit which is equipped with an analytical function is included in either of the sub-systems which relate to the set of telephone terminals to be evaluated and the speech quality of the call is evaluated. Further, use of the packet capturing unit has eliminated the transfer quality evaluation function from the network analyzer. Use of the sound signal sending and receiving unit has eliminated the sound quality evaluation function from the sound quality evaluation unit.

The speech quality evaluation system in the present invention uses the mean value of the amount of sound delay during one evaluation period as the amount of sound delay to calculate the R-value. However, it may be substituted for the amount of the packet delay measured simultaneously.

The speech quality evaluation system in the present invention uses the mean value of the amount of sound delay for an evaluation period as the amount of sound delay to calculate the R-value. However, the amount of sound delay which is measured in real time during the evaluation period may also be used. In this case, for example, when the sound signals which are transmitted and the sound signals which are received are compared, the amount of sound delay in each of the sound parts in the respective sound signals should be measured.

When the speech quality evaluation system in the present invention is used, the recorded natural human sound of the person using the IP telephone service (for example, the person using the analog telephone terminal 110 or terminal 150) may be used for the sound signals used for evaluation which are transmitted by the sound quality evaluation unit. In this case, when the speech quality evaluation system is used, an evaluation can be made which corresponds much better to the speech quality of the call as experienced by the person using the analog telephone terminal.

The speech quality evaluation system in the present invention stores the speech quality evaluation values and the measurement data in a database 510. These values and data can be retrieved using the time information or the terminal-specific information (for example, the telephone number and the SIP address) as keywords in the database 510. In this way, the IP telephone service provider can deal with the matter rapidly if there are any complaints from customers. Since the speech quality evaluation values which are specific to the terminal or terminal group can be read, the database is also effective at the equipment planning stage.

The speech quality evaluation system in the present invention has thus far been explained as a quality evaluation system for use in a telephone service which functions via an IP network which is a type of packet network. However, the speech quality evaluation system in the present invention is effective not only for IP networks but also for speech quality evaluation of telephone services which use other packet networks with unstable transfer quality. In this case, another packet network should be substituted for the IP network 130.

The present invention is configured as indicated above and is effective in the following ways:

The speech quality evaluation system in the present invention receives sound signals at the same time that it transmits sound signals and simultaneously captures packets which correspond to the sound signals both at the sending side and the receiving side. Thus, an evaluation of the speech quality of the call can be made which actually corresponds much better to the speech quality of the call as perceived by a human.

The speech quality evaluation system in the present invention is geared so that it evaluates the speech quality of a call using the prescribed time as a single unit. Thus, the speech quality of the call can be continuously evaluated over a long period of time by repeatedly evaluating the speech quality of that specific call.

The speech quality evaluation system in the present invention is geared so that it evaluates the speech quality of a call using the prescribed time as a single unit. Thus, the speech quality of a call between any two points can be evaluated by changing as appropriate the combination of terminals which carry out the evaluation of the speech quality of a call.

The speech quality evaluation system in the present invention is geared so that the reproduction time and the type of sound signals used for evaluation can be adjusted so that the measurement and evaluation processes are completed within a single evaluation period. Thus, any errors in measurement and evaluation can be kept to a minimum.

The speech quality evaluation system in the present invention is used to measure the amount of packet delay so that any fluctuations in a single evaluation period are evident. The system is used to calculate the R-value using the value for those fluctuations and determines the R-value which matches the speech quality of a call which is actually perceived by a human, without fail.

The speech quality evaluation system in the present invention is geared so that it captures only a packet which corresponds to the sound part of a sound signal. It can reduce the amount of data transfer required to evaluate the speech quality of a call and can also evaluate the speech quality of a call precisely without omission.

The speech quality evaluation system in the present invention is geared so that it cancels a packet under the indicated controls. It can determine the amount of packet delay which matches the speech quality of a call as actually perceived by a human.

The speech quality evaluation system in the present invention uses the natural sound of the person using the telephone service as sound signals used for evaluation so that it can determine an evaluation value which is close to the speech quality of a call as experienced by the user.

The speech quality evaluation system in the present invention is geared so that it accumulates the speech quality evaluation values in a database. Thus, the telephone service provider traces the time back to when a particular problem has occurred and references the speech quality evaluation value. The telephone service provider also references the accumulated speech quality evaluation values, upgrades the equipment and optimizes it in an effective manner.

The speech quality evaluation system in the present invention is geared so that it stores measured data in a measurement database when the speech quality evaluation values and the like have become degraded so that the telephone service provider can specify the factors involved when the speech quality of the call has become degraded.

The speech quality evaluation system in the present invention is geared so that the speech quality evaluation values and the like which are stored in the database are interrogated using the conditions, such as the time information and terminal-specific information and similar data. Thus, the invention can be used to immediately provide information which is useful in planning telecommunications equipment. The telephone service provider can troubleshoot immediately.

The speech quality evaluation system in the present invention is geared so that the control unit carries out remote control of the sound quality evaluation unit and the network analyzer so that it can communicate with these units. Thus, the telephone service provider need not physically send personnel to the site to make the evaluation.

The speech quality evaluation system in the present invention is geared so that it makes a time split between: (1) the measuring process in the speech quality evaluation and (2) data transfer. Thus, the effect of the data transfer on the speech quality evaluation can be held in check or can be eliminated altogether.

The speech quality evaluation system in the present invention is geared so that a sub-system which is provided with a packet capturing unit and a sound signal sending and receiving unit are installed so that they are decentralized and the speech quality of the call can be evaluated, thus making it possible to reduce the costs of operating the system.

The speech quality evaluation system in the present invention is geared so that the amount of delay and defects in the respective sections—when the communication between the telephone terminals is split into multiple sections—are determined and then displayed. Thus, the telephone service provider can clearly specify the cause of the problem when the speech quality of the call has become degraded.

The speech quality evaluation system in the present invention displays the amount of delay determined and the defects by splitting the communication between the telephone terminals into multiple sections by selecting on the screen the location of the degradation when the speech quality evaluation value has become degraded. Thus, the user can move rapidly from utilization of the system to troubleshooting for the system.

What is claimed is:

1. A system which is used to evaluate the speech quality of a call between telephone terminals via a packet network, said system comprising:
a sound signal transmitter which transmits sound signals;
a first packet capturing device which captures a first packet which corresponds to said sound signals;
a sound signal receiver which receives said sound signals which have become degraded while passing through said packet network;
a second packet capturing device which captures a second packet that corresponds to said sound signals which have become degraded; and
a speech quality evaluation means which evaluates the speech quality of a call between said telephone terminals using: (a) sound signals which are transmitted by said sound signal transmitter; (b) sound signals which are received by said sound signal receiver; (c) said first packet; and (d) said second packet.

2. The system of claim 1 wherein said first packet capturing device and said second packet capturing device capture a packet which corresponds to a sound part in said sound signals;

3. The system of claim 1 wherein said speech quality evaluation means determines the amount of sound delay by comparing: (1) said sound signals which are transmitted by said sound signal transmitter; (2) said sound signals which are received by said sound signal receiver for each sound part in the respective signals; and (3) evaluates the speech quality of a call between said telephone terminals using said amount of sound delay.

4. The system of claim 1 wherein said speech quality evaluation means determines the amount of packet delay by comparing: (1) said first packet; and (2) said second packet for each packet which has the same identification number and which evaluates the speech quality of a call between said telephone terminals using said amount of packet delay.

5. The system of claim 1 wherein the system is provided with:
a means which decodes the first decoded sound signals from said first packet; and
a means which decodes the second decoded sound signals from said second packet;
said speech quality evaluation means determines the amount of sound delay by comparing: (1) said first decoded sound signals; and (2) said second decoded sound signals and evaluates the speech quality of a call between said telephone terminals using said amount of sound delay.

6. The system of claim 5 wherein the comparison between said first decoded sound signals and said second decoded sound signals is carried out for each sound part
said packet capturing device

7. The system of claim 3 wherein said speech quality evaluation means evaluates the speech quality of a call between said telephone terminals by determining the R-value using said amount of sound delay.

8. The system of claim 5 wherein said speech quality evaluation means evaluates the speech quality of a call between said telephone terminals by determining the R-value using said amount of sound delay.

9. The system of claim 4 wherein said speech quality evaluation means evaluates the speech quality of a call between said telephone terminals by determining the R-value using said amount of packet delay.

10. The system of claim 8 wherein the system is provided with a display means,
said display means displaying in a time series format the mean value in a prescribed period of time for the R-value which is determined using said speech quality evaluation means; the amplitude of the fluctuations in the mean value within said prescribed period of time for the R-value which is determined is displayed in overlapping fashion.

11. The system of claim 10 wherein said display displays the amount of delay and any defects which have been determined by partitioning into multiple sections the communication between the telephone terminals when the location at which said R-value was degraded has been selected on the display screen.

12. The system of claim 1 wherein the evaluation being carried out in prescribed time units whether or not the evaluation of the communication between said telephone terminals has been completed.

13. The system of claim 12 wherein said system carries out the evaluation in said prescribed time units or carries out the evaluation while changing the combination of said telephone terminals according to a schedule.

14. The system of claim 12 wherein said sound signals which are transmitted by said sound signal transmitter are adjusted so that the evaluation of the communication between said telephone terminals is completed within the prescribed period of time.

15. The system of claim 1 wherein the system is provided with
a database means, said database means storing at least one of the following: sound signals which are transmitted by said sound signal transmitter; sound signals which are received by said sound signal receiver; said first packet; and said second packet, when the quality of the speech which has been evaluated becomes degraded in comparison with the prescribed value.

16. The system of claim 1 wherein said first packet capturing device and said second packet capturing device are provided with a time synchronization means, said capturing means storing a packet which has been captured along with the time stamp showing synchronization.

17. The system of claim 1 wherein said sound signals which are transmitted by said sound signal transmitter are the recorded natural voice of the person using said telephone terminal.

18. A system which evaluates the speech quality of a call between telephone terminals via a packet network, said system comprising:
a sound signal transmitter;
a first packet capturing device;
a second packet capturing device; and
a sound signal receiver;
said sound signal transmitter sends sound signals relative to said sound signal receiver;
said first packet capturing device captures the first packet which corresponds to said sound signals;
said sound signal receiver receives said sound signals which have become degraded in passing through said packet network;
said second packet capturing device captures the second packet which corresponds to the sound signals which have become degraded;
said system further comprises:
a device which determines the first amount of sound delay wherein the first decoded sound signals are decoded from the first packet capturing device and which compares (a) the sound signals which have been transmitted by said sound signal transmitter and (b) said first decoded sound signals;
a device which determines the second amount of sound delay wherein the second decoded sound signals are decoded from the second packet capturing device and compares: (a) said first decoded sound signals and (b) said second decoded sound signals; and
a device which determines the third amount of sound delay by comparing: (a) the sound signals which are received by said sound signal receiver and (b) said second decoded signals.

19. A system which evaluates the speech quality of a call between telephone terminals via a packet network, said system comprising:
a device which determines the amount of packet delay;
said packet delay amount determining device determines the amount of delay for a packet which corresponds to the sound part of a sound signal, said packet passing through said packet network.

20. The system of claim 18 wherein said device used to determine the amount of packet delay decodes said sound signals from a packet which corresponds to the sound part of said sound signals, determines the amount of sound delay and uses this as the packet delay.

21. A system which is used to evaluate the quality of speech between telephone terminals via a packet network, said system comprising:
a device which determines the amount of packet delay; and
a device which determines the R-value;
said packet delay determining device determines the amount of delay for a packet which corresponds to the sound signals which travel through said network for each packet; or it determines the amount of delay for a packet which corresponds to the sound part of sound signals of those packets which travel through said packet network;
said R-value determining device determines the R-value which changes for each packet or for each sound part using the amount of delay for a packet, the delay of which has been determines.

22. A system which is provided with a means which determines the amount of sound delay and evaluates the speech quality of a call between telephone terminals using the amount of sound delay which is determined by said means which is used to determine the amount of sound delay, said system comprising:
said device used to determine the amount of sound delay which determines the amount of sound delay for the sound signals which are exchanged between said telephone terminals for each sound part in the sound signals.

23. The system of claim 22 further comprising a device which transmits sound signals, said sound signals being adjusted so that the evaluation of the communication between said telephone terminals is completed within said prescribed period of time;

24. A system which evaluates the speech quality of a call between telephone terminals via a packet network, said system carries out the speech quality evaluation of the communication between said telephone terminals in prescribed time units whether or not said evaluation has been completed.

25. The system of claim 24 wherein said system carries out the evaluation in said prescribed time units or carries out the evaluation while changing the combination of said telephone terminals according to a schedule.

26. A system for evaluating the speech quality of a call between telephone terminals via a packet network, said system:
a database;
said database stores either sound signals or packet data or both of these which are related to the call between said telephone terminals when the speech quality of a call which has been evaluated is degraded when compared to the prescribed value.

27. A system for evaluating the speech quality of a call between telephone terminals via a packet network, said system comprising:
an R-value determining device; and
a display;
said display displays in a time series format the mean value in a prescribed period of time for the R-value which is determined by said device used to determine the R-value; it displays in overlapping fashion the amplitude of the fluctuations in the mean value within said prescribed period of time for the R-value which is determined.

28. The system of claim 27 wherein said display displays the amount of delay and any defects which have been determined by partitioning the communication between the telephone terminals into multiple sections.

29. A system which evaluates the speech quality of a call between telephone terminals, said system comprising:
a device used to determine the amount of delay; and
a display;
said display displays in a time series format the mean value at a prescribed period of time for the amount of delay which is determined by said device used to determine the amount of delay, and displays the amplitude of fluctuations in the mean value in said prescribed period of time which is determined in overlapping fashion.

30. An apparatus which determines the amount of packet delay between a first point and a second point in a packet network, said apparatus comprising:
a device which captures a first packet at a first point;
a device which captures a second packet at a second point;
a first decoder which decodes a first sound signal from the first packet;
a second decoder which decodes a second sound signal from the second packet; and
a device which determines the amount of sound delay by comparing said first sound signal and said second sound signal and uses said amount of sound delay as the amount of packet delay between said first point and said second point.

31. The apparatus of claim 30 wherein the comparison is made between said first sound signal and said second sound signal for each sound part of the respective signals.

32. An apparatus which is used to determine the amount of delay, said apparatus comprising:
a transmitter which is used to transmit sound signals;
a packet capturing device which is used to capture a packet which corresponds to said sound signals; and
a decoder which is used to decode sound signals from a packet which has been captured by said packet capturing device;
and which compares said sound signals and said decoded sound signals and determines the amount of sound delay.

33. The apparatus of claim 32 wherein a comparison of said sound signals and said sound signals which have been decoded is made for each sound part of the respective signals.

34. An apparatus which is used to determine the amount of delay, said apparatus comprising:
a receiver which is used to receive the sound signals;
a packet capturing device which captures a packet which corresponds to said sound signals; and
a decoder which is used to decode the sound signals from a packet which has been captured by said packet capturing device; compares said sound signals and said sound signals which have been decoded and determines the amount of sound delay.

35. The apparatus of claim 34 wherein a comparison of said sound signals and said sound signals which have been decoded is made for each sound part of the respective signals.

36. An apparatus for determining the amount of sound delay, said apparatus comprising:
a transmitter which is used to transmit the sound signals;
a receiver which is used to receive said sound signals; and
a device which is used to determine the amount of sound delay by comparing: (a) said sound signals which are transmitted by said transmitter; and (b) said sound signals which are received by said receiver for each sound part of the respective signals.
